(19) United States
(12) Patent Application Publication
(10) Pub. No.: US 2020/0370727 A1
(43) Pub. Date: Nov. 26, 2020

(54) EXTERNAL LUMINOUS SIGNALING VEHICLE GLAZING, VEHICLE INCORPORATING SAME AND MANUFACTURE

(71) Applicant: SAINT-GOBAIN GLASS FRANCE, COURBEVOIE (FR)

(72) Inventors: Mathieu BERARD, PARIS (FR); Olivier DELRIEU, EPINAY SUR ORGE (FR); Pascal BAUERLE, DAVENESCOURT (FR)

(21) Appl. No.: 16/768,464

(22) PCT Filed: Nov. 28, 2018
(86) PCT No.: PCT/FR2018/053022

§ 371 Date: May 29, 2020

(30) Foreign Application Priority Data
Nov. 30, 2017 (FR) 1761449

(51) Int. Cl. F21S 43/20; F21S 43/145; G02B 27/30; G02B 5/04; B32B 3/26; B32B 3/30; B32B 17/10; B32B 1/00; B32B 7/12; B32B 37/02; B60Q 1/26

(52) U.S. Cl. CPC F21S 43/26; F21Y 2115/15; G02B 27/30; G02B 5/045; B32B 3/263; B32B 3/30; B32B 17/10036; B32B 17/10541; B32B 17/10761; B32B 17/1077; B32B 17/10788; B32B 17/10779; B32B 1/00; B32B 7/12; B32B 37/02; B60Q 1/268; B60Q 1/2696; F21S 43/145

(57) ABSTRACT

An exterior light signaling vehicle glazing selected from a rear window and a side window or a windshield, includes a first glazing which forms an outer glazing and has first and second main faces; a superficially light emitting element such as an OLED or QLED; a holographic redirecting optical system or collimating optical system with one or more optical films followed by a redirecting optical system with one or more optical films.

The invention relates to an external luminous signaling vehicle glazing and to a vehicle including such a glazing and to the manufacture of such a glazing.

External luminous signaling vehicle glazings are increasingly common. In particular it is common to place a lighting unit on the internal face called face F2 in order to form a 3rd stoplight.

The integration and the manufacturing process may be improved.

To this end, the first subject of the present patent application is an external luminous signaling vehicle glazing, chosen from a rear window (back window) and a side window (preferably fixed, deflector) or a windshield, in particular that of a motor vehicle or even that of a public-transport vehicle, comprising:
a transparent first glazing made of optionally clear or extra-clear mineral, in particular (thermally or chemically) tempered or organic glass that is preferably curved, intended to be the exterior glazing, with first and second main faces called face F1 (face outside the vehicle) and face F2, respectively, and, for motor vehicles, in particular a glazing made of mineral or organic glass of thickness that is preferably at most 2.5 mm, even at most 2.2 mm—in particular 1.9 mm, 1.8 mm, 1.6 mm and 1.4 mm- or even of at most 1.3 mm or of at most 1 mm, preferably with a reference direction,
a light source, which is an electroluminescent element, face-F2 side and able to emit external signaling light (therefore toward face F2)—chosen so as to meet with standards, for example amber or (MV) yellow light for a side-repeater light or even (MV) red light for a (3rd) light (stoplight)—, said light source having an exit surface toward face F2 (and an entrance surface opposite), and with an emission half angle at the apex of 50° to 70°, in particular 55 to 65°, and a main emission direction normal to the plane of said electroluminescent element, and even normal to the (mean) plane of the glazing (preferably 90±5°, 90±2° and even 90°)
   the in particular transparent electroluminescent element has an emitting area of length of at least 5 cm and better still of at least 10 cm and even a width of at least 1 cm or 2 cm and better still at least 5 cm, and is preferably of thickness E0 that is subcentimeter-sized and better still submillimeter-sized.

Preferably, in a (first) configuration the glazing includes, facing said electroluminescent element, between face F2 and said electroluminescent element, a collimation optic having a rear face exit-surface side and a front face called the collimation face opposite the rear face.

The collimation optic, which is made of transparent and/or even flexible preferably plastic material (in particular thermoplastic, polyethylene terephthalate PET, polyethylene naphthalate PEN, polyethylene PE, polymethyl methacrylate PMMA, polydimethylsiloxane PDMS, polyamide, polyimide, polyacrylate, polyester, polycarbonate, polysulfones, polyethersulfones, thermoplastic polyurethane) is preferably of (total) thickness E1 that is submillimeter-sized and better still of at most 0.6 mm or 0.3 mm or 0.15 mm. The collimation optic includes, and even is, a preferably plastic (in particular thermoplastic, PET, PE, PC, PMMA, PDMS) optical film, said film in particular being partially textured in its thickness or as an alternative being a composite film including a smooth (in particular plastic, chosen from the aforementioned plastics) transparent carrier with a transparent overlayer that is partially or entirely textured in its thickness) or a set of preferably plastic (chosen from the aforementioned plastics) optical films, each including an array of features with apexes S and with a pitch T between apexes that is preferably from 10 μm to 500 μm, with preferably at least 4 or even 10 features facing the exit (or light-emitting) surface.

The collimation optic according to the invention thus includes:
a) a first and preferably single optical film, with on the front face called the collimation face said array of two-dimensional features (toward the face F2), in particular a film textured with said array, in particular with a thickness of at most 0.3 mm or 0.2 mm or 0.15 mm
b) or a set of at least two optical films that are prismatic, preferably of at most two prismatic optical elements, including in this order starting from the exit surface:
   a first optical film with on a main face opposite to the exit face (called the intermediate face) a first array of prisms (prismatic features) or, in particular a first film textured with said first array, extending longitudinally (along their length) along a first axis, in particular with a thickness that is submillimeter-sized and even of at most 0.3 mm or 0.2 mm or 0.15 mm
   and facing the first optical film (preferably spaced apart therefrom by at most 1 mm or fastened on its periphery for example by adhesive bonding or welding) a second optical film with on a main face opposite to the exit surface (preferably forming said front face) a second array of prismatic features, in particular a film textured with said second array,—crossed with the first array of prismatic features —, the second array of prisms (prismatic features) extending longitudinally along a second axis making an angle to said first axis of 90±10°, preferably 90±5°, or 90±2° and even of 90°, the first or the second axis making with the reference direction an angle of at most 10°, better still of at most 5° and even of at most 2°; and even is parallel (angle of 0°), in particular with a thickness that is submillimeter-sized and even of at most 0.3 mm or 0.2 mm or 0.15 mm
c) or a single first optical film with on the front face called the collimation face a first array of prisms (prismatic features), in particular a film textured with said first array, extending longitudinally along an axis making an angle of at most 10° better still at most 5° and even at most 2° to the reference direction and even parallel, in particular with a thickness E0 that is submillimeter-sized and even of at most 0.3 mm or 0.2 mm or 0.15 mm.

For b) and c) each prism is defined by two longitudinal faces the prism preferably having a length L and a width W with L>2W and better still L>5W or L>10W.

Each prism has an angle a0 at the apex ranging from 60 to 110°. Furthermore, each longitudinal face makes an angle a1, a2 ranging from 30 to 55°, better still from 35 to 50°, even from 40 to 50° and even of 45°±5°, 45±1° or of 45° to the plane of the film; a1−a2 is preferably smaller than 5° and even than 2° (so-called symmetric prisms). In particular for b) and c):
all or some of the prisms are pointed with the two longitudinal faces planar and secant at the apex S each pointed prism being defined by the angle a0 at the apex ranging from 60 to 110°, better still from 70° to 110°, even from 80° to 100° and even of 90°±5°, 90°±2° or of 90°, each longitudinal face making an angle a1, a2 ranging from 30 to 55°, better still from 35 to 50°, even from 40° to 50° and even of 45°±5°, 45°±1° or of 45° to the plane of the film, the difference a1−a2 between said angles (defined by the longitudinal faces) preferably being smaller than 10°, than 5° and even than 2° (so-called symmetric prisms)
all or some of the prisms are rounded with the two longitudinal faces (each curved or at least partially curved optionally with a planar portion then curved toward the apex), in a plane P normal to the plane of the film and normal to said axis of the prism; the intersection between the plane P and each rounded prism forms a section including two curves C1, C2 that are contiguous at the apex S; two straight lines D1 and D2 passing through the inflection points I1 and I2 of the two curves C1, C2 are defined; each straight line makes an angle a1, a2 ranging from 30 to 55°, better still from 35 to 50°, even from 40° to 50° and even of 45°±5°, 45°±1° or of 45° to the plane of the film, and preferably the difference a1×a2 between said angles (defined by the straight lines D1 and D2) is smaller than 10°, than 5° and even than 2° (so-called symmetric prisms)
   each rounded prism being defined by a circle tangent to the apex S with a radius of curvature R1 comprised between T/10 and T/5 (these straight lines D1 and D2 are secant and make an angle a0 (corresponding to the angle at the apex) ranging from 60 to 110°, better still from 70° to 110°, even from 80° to 100° and even of 90°±5°, 90°±2 or of 90°).
   for a) each two-dimensional feature being defined by a flank, in particular at least 3 secant lateral faces, the two-dimensional feature preferably has an aspect ratio of length L to width W higher than or equal to 1 and of at most 2, even at most 1.5 or of at most 1.1.

When the prisms are contiguous valleys—which are pointed or rounded—are defined with the same tolerances in the angle in the valley as in the angle at the apex described above and in the optional radius of curvature in the valley.

For a) in a plane P normal to the film, the two-dimensional feature has an angle a0 ranging from 60 to 110°, better still from 70° to 110°, even from 80° to 100° and even of 90°±5°, 90°±2° or of 90°, each intersection of the flank with the plane P making with the plane of the film an angle a1, a2 ranging from 30 to 55°, better still from 35° to 50°, even from 40° to 50° and even of 45°±5°, 45°±1° or of 45°, the difference a1×a2 between said angles (defined by the 2 intersections) being smaller than 10°, than 5° and even than 2° (so-called “symmetric” prisms). In particular for a):
all or some of the two-dimensional features being pointed, for each pointed two-dimensional feature the intersection between a plane P normal to the film passing through the apex S and the pointed two-dimensional feature forms a triangular section including two straight lines D1 and D2 that are secant at the apex S making the angle a0 at the apex ranging from 60 to 110°, better still from 70° to 110°, even from 80° to 100° and even of 90°±5°, 90°±2° or of 90°,
each straight line D1, D2 making with the plane of the film an angle a1, a2 ranging from 30 to 55°, better still from 35 to 50°, even from 40 to 50° and even of 45°±5°, 45±1° or of 45° to the plane of the film, the difference a1×a2 between said angles preferably being smaller than 10°, than 5° and even than 2° (so-called “symmetric” prisms)
all or some of the two-dimensional features being rounded, for each rounded two-dimensional feature the intersection between a plane P normal to the plane of the film passing through the apex S forms a section including two curves C1, C2 that are contiguous at the apex S′, two straight lines D1 and D2 passing through the inflection points I1 and I2 of the two curves being defined, said straight lines each making an angle a1, a2 ranging from 30 to 55°, better still from 35° to 50°, even from 40° to 50° and even of 45°±5°, 45°±1° or of 45° to the plane of the film, and in said plane P each rounded prism is defined by a circle that is tangent to the apex S and that has a radius of curvature R1 comprised between T/10 and T/5 (these straight lines D1 and D2 are secant and make said angle a0 at the apex ranging from 60 to 110°, better still from 70° to 110°, even from 80° to 100° and even of 90°±5°, 90°±2 or of 90°).

In said configuration, the glazing furthermore comprises facing the collimation optic a (so-called asymmetric) redirection optic, between the collimation optic and the face F2 and preferably on the collimation optic (fixed to its periphery, for example by adhesive bonding or welding, or spaced apart therefrom by at most 1 mm), made of a transparent preferably plastic (in particular thermoplastic, polyethylene terephthalate PET, polyethylene naphthalate PEN, polyethylene PE, polymethyl methacrylate PMMA, polydimethylsiloxane PDMS, polyamide, polyimide, polyacrylate, polyester, polycarbonate, polysulfones, polyethersufones, thermoplastic polyurethane) material,—for example the same material as the (last) optical collimation film or the collimation films), which is preferably of thickness E′1 that is submillimeter-sized and even of at most 0.5 mm or 0.3 mm, includes a preferably plastic optical film or a set of preferably plastic optical films, each including on a main face opposite to the exit surface an array of asymmetric prisms with apexes and with a pitch T′ between apexes that is from 10 μm to 500 μm, preferably with a least 4 or even 10 features facing the exit surface (or light-emitting area), the redirection optic thus includes:

i) a first optical film that is asymmetric prismatic with said array of asymmetric prisms extending longitudinally along a third axis making an angle of at most 10°, at most 5° or most 2° to said first axis and even parallel and/or to the reference direction of the glazing, in particular with a thickness that is submillimeter-sized and even of at most 0.3 mm or 0.2 mm or 0.15 mm
j) or a set of two asymmetric optical films that are prismatic, including in this order starting from the exit surface:
an asymmetric first optical film with an array of asymmetric prisms, extending longitudinally along a third axis, in particular with a thickness that is submillimeter-sized and even of at most 0.3 mm or 0.2 mm or 0.15 mm, the third axis each makes an angle to the reference direction (and even to the first axis), of at most 10°, of at most 5° or at most 2° and even is parallel (0°).
and facing the first asymmetric optical film (preferably spaced apart therefrom by a most 1 mm or fastened to its periphery for example by adhesive bonding or welding) a second optical film in particular with a thickness of at most 0.3 mm or 0.2 mm or 0.15 mm, with a second array of prismatic features—which array is crossed with the first array of prismatic features-, extending longitudinally along a fourth axis making an angle to said third axis of at most 10°, preferably of at most 5°, of at most 2° and even of 0° and/or the fourth axis makes an angle to the reference direction (and even the first axis), of most 10°, of at most 5° or of at most 2° and even is parallel (or 0°).

For i) and j) each asymmetric prism is defined by first and second longitudinal faces the prism preferably having a length L and a width W with L>2W and better still L>5W or L>10W.

Each asymmetric prism has an angle a′0 at the apex ranging from 50 to 60° and better still of 55°±5° or 55°±2° and the first longitudinal face (called the long side) makes to the plane of the asymmetric optical film a first angle a3 ranging from 31 to 41° and better still of 35°±5° or 35°±2°. Naturally, the second longitudinal face (called the short side) preferably makes to the plane of the asymmetric optical film a second angle a4, ranging from 79 to 99° or 90° better still from 85 to 90°, or from 88 to 90°, and preferably of at most 90°. Preferably, the difference a4−a3 is larger than 40° and even than 50°.

In particular, for i) and j):
all or some of the asymmetric prisms being pointed with the two longitudinal faces planar and secant at the apex S1 each pointed prism being defined by said angle at the apex a′0
all or some of the asymmetric prisms being rounded with the two longitudinal faces (each curved or at least partially curved optionally with a planar portion then curved toward the apex), in a plane P normal to the plane of the film and normal to said axis of the prism, the intersection between the plane P and each rounded prism forms a section including two curves C′1, C′2 that are contiguous to the apex S1,
   first and second straight lines D′1 and D′2 passing through the inflection points I′1 and I′2 of the two curves C′1, C′2 are defined,
a first straight line D′1 making said angle a3 to the plane of the film,
a first second line D′2 making said angle a4 to the plane of the film,
   each rounded asymmetric prism being defined by a circle tangent to the apex S1 with a radius of curvature R1 comprised between T′/10 and T′/5 (the straight lines D′1 and D′2 are secant and make said angle at the apex a′0).

When the asymmetric prisms are contiguous valleys—which are pointed or rounded—are defined with the same tolerances in the angle in the valley as in the angle at the apex described above and in the optional radius of curvature in the valley.

The normal to the long side directed toward the face F2 is oriented toward the top of the rear window or of the windshield or toward the front of the side window Furthermore, in the (first) configuration:
the reference direction for the rear window or the windshield is the horizontal in the plane of the window or windshield
   and, to preserve the collimation and/or redirection function:
air is between the exit surface (which is smooth or already textured in order to promote light extraction, such as with a lenticular array etc.) and the entrance face of the first optical film of the collimation optic (smooth face, without coating, without micron-sized texture, etc.), in particular the first optical film, being spaced apart from the exit surface preferably by at most 1 mm or fastened to its periphery for example by adhesive bonding and with an optional spacer or even by welding, optionally makes physical (non-optical) contact, optionally makes physical contact with the exit surface, and for example is spaced apart therefrom by at most 1 mm
for b) and c) air is between the prisms of the front face of the collimation optic, and in particular the apexes of the features are spaced apart or make physical contact with a transparent element (optional second film or asymmetric prismatic film)
for a) the two-dimensional features are recessed, the array of two-dimensional features is an array of cavities (the wall of each cavity forming the flank in particular the contiguous secant lateral faces or the conical flank), the apexes S are oriented to opposite face F2 and the top surface of each cavity (in particular defining the outline of the base) is spaced apart from or in physical contact with the (first) asymmetric prismatic film, or the two-dimensional features are raised and oriented toward face F2, the apexes of the features of each front face are spaced apart or in physical contact with the (first) asymmetric prismatic film and air is between the two-dimensional features
the front face of the last asymmetric prismatic film is spaced apart from or in physical contact with a distinct transparent element in particular of thickness that is preferably subcentimeter-sized (protective and/or functional film, face F4 of a second glazing if the glazing is laminated) and even of at most 0.3 mm or 0.15 mm or corresponding to the first glazing (face F2 of the first glazing).

In a (second) alternative configuration to the collimation/redirection optic assembly described above, the glazing includes, facing the exit surface a holographic redirection optic, in particular made of a transparent material that is preferably plastic, in particular thermoplastic (preferably made of polyester or of polyethylene terephthalate PET, polyethylene PE polycarbonate PC, polymethyl methacrylate PMMA, polystyrene, polyamide, polydimethylsiloxane PDMS, polyethylene naphthalate PEN, polyimide, polyacrylate, polysulfone, polyethersulfone, thermoplastic polyurethane), preferably on the exit surface (fastened to its periphery, for example by adhesive bonding or even welding or spaced apart therefrom by at most 1 mm); the holographic redirection optic includes a front face toward face F2 and an opposite rear face; the holographic redirection optic, includes, better still is, an in particular plastic film with an array of holographic features (one-dimensional and for example prismatic features) on the front face, preferably of thickness that is submillimeter-sized and even though the most 0.3 mm or 0.15 mm.

Furthermore, in this alternative (second) configuration, air is between the exit surface and the entrance face of the holographic redirection optic, air is between the holographic features of the final front face of the holographic redirection optic; the front face of the holographic redirection film is spaced apart or makes physical contact with a distinct transparent element that is of thickness that is preferably subcentimeter-sized (protective and/or functional film, face F4 of a second glazing if the glazing is laminated) and even of at most 0.3 mm or 0.15 mm or corresponding to the first glazing.

Furthermore, in these configurations:
the reference direction for the rear window or the windshield is the horizontal in the plane of the rear window or windshield (for a redirection toward the ground)
and the reference direction for the side window is the normal to the horizontal in the plane of the window for a redirection toward the rear.

According to the invention, to guarantee their effectiveness, any even transparent material (adhesive, lamination interlayer) is avoided between the features of each film and in particular an air gap is created between the exit surface and the entrance face of the first optical film.

A physical contact (film against exit surface) is tolerated but an air-filled cavity achieved by a peripheral fastening (preferably by adhesive bonding) with or without spacer is preferred (better controlled thickness, less risk of iridescent zones).

According to the invention, the (even each) peripheral fastening is preferably entirely outside (offset from, therefore peripheral to) the light-emitting area. The width of the fastening may be at most 5 mm.

The one or more optical films according to the invention are effective, simple to implement and may be thin with a total thickness of at most 1 mm or even 0.5 mm.

The (collimation and redirection) films may together form a stack that is fastened on its periphery to the exit surface.

The assembly consisting of the electroluminescent element, collimation optic and redirection optic may be flat, parallel to face F2, and pressed or adhesively bonded on its periphery against face F2 or face F4 of a laminated glazing. The assembly consisting of the electroluminescent element and holographic redirection optic may be flat, parallel to face F2, and pressed or adhesively bonded on its periphery against face F2 or face F4 of a laminated glazing.

This assembly may be compact, of total thickness of at most 10 mm or of at most 5 mm.

The electroluminescent element is a (quasi-) Lambertian source. It is an extended source as opposed to point-like sources such as the inorganic light-emitting diodes referred to as LEDs.

The electroluminescent element such as an OLED or QLED may already have adhesively bonded to its exit surface a film with a lenticular array or equivalent for extracting the light (often called an EEL, for “external extraction layer”) or an exit surface textured for this purpose.

The electroluminescent element is preferably a rectangular strip. Preferably, the light-emitting area is a single active area or a set of elementary active areas preferably of length of at least 1 or 2 cm that are arranged, spaced apart so as to produce uniform light in a preferably rectangular area. The single active area is preferably rectangular. The elementary active areas are preferably square or rectangular.

Pointed features with planar faces are preferred but a manufacturing defect may lead to undulated features (curved flank and rounded summit). These features are acceptable such as delimited according to the invention.

Naturally, it is preferred for b) or c) to form a set of prismatic features (prisms) that are one-dimensional along the longitudinal axis. If for manufacturing reasons, etc. the one-dimensional prism is divided into pieces in the length direction then the pieces are spaced apart by a different smaller than <5 L better still than 10 L or than 20 L.

The features (prisms or two-dimensional features) are as close as possible to one another and for example their bases are separated by less than 1 mm and preferably by less than 0.5 mm.

Even more preferably, the prisms or the two-dimensional features and the asymmetric prisms are contiguous or essentially contiguous.

Features (prisms etc.) are said to be contiguous when they touch each other in at least one portion of their surface. It is preferable for the features to be contiguous because they are thus more numerous and effective. For example, for each prismatic film, there is one set of prismatic features that are one-dimensional along the longitudinal axis, the bases of which features are contiguous.

Certain two-dimensional features do not allow complete contiguousness between the features. This is in particular the case when if the bases are circles, even if they touch, there remains a certain area between the circles not belonging to the features. By complete contiguousness, what is meant is the fact that the outline of the base of a feature also in its entirety forms part of the outlines of the neighboring features thereof.

Certain features may be completely contiguous, so that the entirety of the area (at least the functional area facing the electroluminescent element) of the optical film forms part of at least one feature. It is a question of a tessellation. In particular, two-dimensional features with square or rectangular or hexagonal bases may be completely contiguous if electroluminescent the bases are identical. In the case of square or rectangular bases, said bases should also be aligned if the features are to be completely contiguous. In the case of hexagonal bases, it is advisable for said bases to form a honeycomb.

Each textured transparent film covering the electroluminescent element (the OLED or QLED preferably) may be textured regionwise, and therefore comprise one or more textured regions, directly opposite an (OLED or QLED) electroluminescent element or a plurality of (OLED or QLED) electroluminescent elements, and the adjacent regions (offset from the OLEDs or QLEDs) are smooth (in order to leave some transparency).

Preferably the collimation optic and/or the redirection optic does not extend beyond the edge face of the first glazing.

When the glazing includes a plurality of electroluminescent elements such as OLEDs or QLEDs it may preferably include one collimation optic and even one redirection optic per (OLED or QLED) electroluminescent element or a collimation optic that is common, and even a redirection optic that is common, to a plurality of (OLED or QLED) electroluminescent elements. The collimation optic and even the redirection optic is preferably as local as possible because this generates haze. In case of a common collimation optic (and even of a common redirection optic) the films may be smooth between the electroluminescent elements or with features but over a smaller width (collimation optic and even redirection optic) of the films, for example of at most 5 cm/1 cm.

In particular for the OLED, the glazing may comprise a color filter:
between the exit surface and the rear face of the collimation optic in particular first optical film
   or
between the exit surface and the entrance face of the holographic collimation optic in particular optical film
between the final front face and face F2 adhesively bonded to F2 or to the periphery of the final front face of the optionally holographic redirection optic
or between the redirection optic and a lamination interlayer, then forming a local protective film.

Preferably, for the optical films according to the invention, it is preferably a question of repetitive geometric features, i.e. geometric features having substantially the same shape and placed at substantially equal distance from one another and even of substantially the same height.

Of course, the shape of the zone covered by the collimation or redirection optic is independent of the shape of the features.

A two-dimensional feature may therefore be:
raised and therefore solid, for example with a conical or pyramidal surface, and in particular with secant lateral faces separated by lateral ridges,
recessed (in other words inverted)—the film is textured with an array of cavities, the one or more walls of each cavity forming the pyramidal lateral faces or the conical flank; the apex is oriented toward opposite face F2 and the top surface of the cavity defines the outline of the base.

The two-dimensional features for example end in a tip, such as is the case for a cone or a pyramid.

Preferably, each two-dimensional feature has the planar and secant (lateral) faces of a pyramid. If a two-dimensional feature is a regular pyramid, the base (comprised in the general plane of the textured face of the film) is an equilateral triangle.

A conventional cone does not have any planar surfaces on its flank.

The entrance of each optical film has a low roughness so as to prevent any scattering. Independently of the roughness, it is possible to define a feature (texture) depth or height that is equal to the distance between the highest point and the lowest point of a feature.

The features (prisms or two-dimensional features) preferably are 10 μm to 500 μm in height and better still between 100 and 300 μm in height, and preferably have a height of at least 50 μm and of at most 200 μm.

The height of each optical film (collimation optic and redirection optic) may be comprised between 5 μm and 1 mm, preferably between 10 μm and 500 μm, and in particular between 20 and 300 μm, and is preferably at least 50 μm and at most 200 μm.

The transparent optical film may be a film made of a plastic (organic polymer) material chosen from the plastics already mentioned and is preferably made of polyester, of polyethylene terephthalate or PET, polycarbonate or PC or polymethyl methacrylate PMMA.

The transparent optical film is preferably flexible in order to match the one or more curvatures of the (monolithic or laminated) glazing if it is curved.

The optical film (collimation optic or redirection optic) may comprise a plastic film with, on its surface, a transparent layer with said features, the thickness of said layer being partially or entirely textured.

Preferably, each optical film (collimation optic and redirection optic) is a (monolithic) plastic film the thickness of which is partially textured; in other words there is a constant thickness between the smooth entrance face and the closest point of the textured front face (F2-side). Preferably, the remaining (constant) thickness of the film is defined as the distance between the lowest point between the textured front face and the rear face. The remaining thickness is at least 50 μm and even at most 200 μm.

The texture may be produced by rolling (i.e. cast), thermoforming, etching and in particular laser etching for a polymer material. Depending on the shape of the desired texture, the manufacture may not necessarily lead to perfect geometric shapes: rounded valley or apex, etc.

The collimation optic according to a) or b) may be a first textured transparent film.

The collimation optic according to c) may be a first textured transparent film and a crossed second textured transparent film.

The redirection optic according to i) may be a first textured transparent film.

The redirection optic according to j) may be a first textured transparent film and a crossed second textured transparent film.

Preferably, regarding the collimation optic and/or the redirection optic, the following preferably cumulative features are preferred:
the or each optical film is a plastic film that is partially textured in its thickness, the height H of the features preferably having a dispersion of at most 10%
for a) the two-dimensional features are recessed, the plastic film in particular being partially textured in its thickness; the two-dimensional features have a rectangular, square or circular base and preferably have a height H with a dispersion of at most 10%; the features are in particular (almost) of the same height and therefore have top surfaces in the same plane
for a), b) or c) the angle at the apex A1 is 90°±5° and even the angle A2 is 45°±5° and even the angle at the apex A1 is 90°±2° and even the angle A2 is 45°±2°
for i) and j) the angle at the apex A1 is 55°±5° and even the angle A2 is 35°±5° and even the angle at the apex A1 is 55°±2° and even the angle A2 is 35°±2°.

Preferably, with respect to the electroluminescent element, the following preferably cumulative features are preferred:
the electroluminescent element is an organic light-emitting diode, i.e. a so-called OLED, in particular a transparent OLED (TOLED) or a quantum-dot light-emitting diode, i.e. a so-called QLED, or even a TFEL (thin-film electroluminescent)
the electroluminescent element, in particular an OLED or QLED, is transparent, and has a light transmittance of at least 20% and even of at least 50%.
the electroluminescent element is a back-emitting OLED including a carrier that bears on the side opposite to face F2 an optional functional sublayer, a transparent anode, an organic electroluminscent system, a reflective cathode, in particular with on the surface on the side opposite to face F2, and even one or more dark edges adjacent to the luminous area (for example technical edges, for the electrical powersupply) for example of width that is subcentimeter-sized of at most 1 cm or 5 mm or 1 mm, the collimation optic and even the redirection optic being fastened (adhesively bonded or even welded, etc.) preferably at least partially facing the technical edges.

The OLED may also comprise an encapsulation layer covering the assembly (the active area): resin that is for example transparent or even adhesive-coated plastic film, this plastic film equipped with electrically conductive zones may serve for the electrical connection.

In particular, in a vehicle the forward emissions are white; rearward emissions are red; and sideways emissions are amber (MV yellow).

For the rear window, the assembly consisting of the light source (OLED in particular) and collimation optic and redirection optic may form a (third) stoplight or an indicator (side repeater) light, a position light or a sidelight.

For the rear window or the windshield, the assembly consisting of the light source (OLED in particular) and holographic redirection optic forms a (third) stoplight or an indicator (side repeater) light, a position light or a sidelight or the light source (OLED in particular) is a symbolism, an in particular horizontal pictogram (symbol, letters signs etc.) on the lower or lateral border of the window or even in the center of the window, in particular a warning pictogram such as a hazard warning light, or a pictogram providing a warning with regard to traffic, or provides information in particular on safety distance.

The light source may be a strip that is straight or curved, for example along a curved edge or a masking outline (of an opaque in particular black enamel layer), etc. of the window.

For example (for the rear window or the windshield) the light source (OLED in particular) preferably emits in the (MV) red and in particular is a luminous strip that is preferably rectangular and peripheral and even horizontal.

For example (for the rear window or the windshield) the light source (OLED in particular) preferably emits in the (MV) yellow and in particular is a luminous strip that is preferably rectangular and peripheral and even horizontal, in particular horizontal on the lower or lateral border of the window.

In particular, the light source (OLED in particular) is a rectangular and peripheral, and in particular horizontal, luminous strip on the lower or lateral border of the rear window, the assembly consisting of the light source and collimation optic and redirection optic in particular forming an indicator (side repeater) light, a position light, a sidelight or the assembly consisting of the light source and holographic redirection optic forming an indicator (side-repeater) light, a position light or a sidelight.

In particular, the in particular OLED light source is a symbolism or a pictogram and in particular is horizontal on the lower or lateral border of the window or even in the center of the window, in particular a warning pictogram such as a hazard warning light, or a pictogram providing a warning with regard to traffic, or provides information in particular on safety distance.

In particular, the in particular OLED light source emits in the (MV) red, and in particular is a preferably rectangular and peripheral luminous strip that is therefore on the border of the vision area and in particular on the upper border of the window (face F4 or F2) and centered, the assembly consisting of the light source and collimation optic and redirection optic forming a third stoplight, a position light or a sidelight or the assembly consisting of the light source and holographic redirection optic forming a third stoplight, a position light or sidelight.

In particular, (for the rear window or the windshield) the light source emits in the (MV) yellow, and in particular is a preferably rectangular and peripheral luminous strip that is therefore on the border of the vision area and in particular on the lower border of the window (face F4 or F2), the assembly consisting of the light source and the collimation optic and the redirection optic for example forming an indicator light or the assembly consisting of the light source and holographic redirection optic forming for example an indicator (side repeater) light.

To produce a (MV) red—or yellow—light for the rear window it is possible to a use an electroluminescent element (such as an OLED or QLED) that emits a white light and then use a red—or yellow—color filter. A local protective film between the front final face and face F2 may be said color filter (of red and/or any other necessary color).

The rear window may be in a trunk door, a utility vehicle door or may even be a back window.

The light source may be opaque and/or masked from the interior by a masking layer (on F4 if laminated glazing and source between F2 and F3) or by a protective film.

It may be desired to prevent the light from entering the interior (mono directional) in particular via the side window and windshield.

The light source may be transparent and/or masked from the interior by a masking layer (on F4 if laminated glazing and source between F2 and F3) or by a protective film.

An exterior masking layer (on face F2) may be provided with an aperture plumb with the light source.

One or more lights of other colors: blue, orange, green, etc., may be desired.

Provision may be made for a plurality of OLED or TFEL or QLED luminous zones (each being a strip of rectangular, square or any other desired shape) with an optionally identical color and that are controlled together (on and off simultaneously for example)—that perform the same function for example—and that, for example, are spaced apart by more than 80 mm or 75 mm.

The rear (or side) window (or windshield) may include a plurality of in particular OLED or TFEL or QLED electroluminescent elements each with a holographic redirection optic or with an assembly consisting of the collimation optic and the redirection optic, said light sources in particular on the upper border of the rear window emitting an optionally identical color

For the windshield it may be a question of a forward-directed light such as a DRL (daytime running light) or a luminous pictogram, etc.

For the side window, which is in particular fixed, as a deflector, the assembly consisting of the in particular OLED or TFEL or QLED light source and the collimation optic and asymmetric redirection optic may form an indicator (side repeater) light or the assembly consisting of the light source and the holographic redirection optic may form an indicator (side repeater) light.

For example, the in particular OLED or TFEL or QLED light source emits in the (MV) yellow, and is a preferably rectangular, peripheral luminous strip that is therefore on the border of the vision area and in particular on the lower or lateral and even rear lateral, the assembly consisting of the light source and the collimation optic and the redirection optic forming a side-repeater indicator light or the assembly consisting of the light source and holographic redirection optic forming a side-repeater indicator light.

The side window may be of rectangular or quadrilateral shape (smaller top edge).

To produce a (MV) yellow light for the rear window it is possible to a use an electroluminescent element (such as an OLED or QLED) that emits a white light and then use a yellow filter. A local protective film between the final front face and face F2 may be said filter.

The light source (such as an OLED or QLED light source) may also be a symbolism or a pictogram.

For example, for a side window a plurality of OLEDs or TFELs or QLEDs are chosen, each with a holographic redirection optic or with an assembly consisting of a collimation optic and a redirection optic, said light sources being spaced apart by at most 85 mm and being arranged horizontally or even vertically (or laterally at least).

The glazing may comprise a laminated glazing including:
said first (transparent) glazing,
a second (transparent) glazing, intended to be the interior glazing, which is made of preferably curved and preferably clear or extra-clear or even tinted (less than the first glazing) mineral or even organic glass, with third and fourth main faces, face F3 and face F4, respectively, for a motor vehicle, preferably of thickness smaller than that of the first glazing, even of at most 2 mm—in particular 1.9 mm, 1.8 mm, 1.6 mm and 1.4 mm—or even of at most 1.3 mm or of less than 1.1 mm or even of less than 0.7 mm and in particular of at least 0.2 mm, the total thickness of the first and second glazings preferably being strictly smaller than 4 mm, and even than 3.7 mm, the second glazing possibly being chemically toughened between faces F2 and F3, which are the internal faces of the laminated glazing, a transparent lamination interlayer, which is optionally clear, extra-clear or even tinted, in particular grey or green (partially tinted in its thickness if a multilayer for example), that is made of preferably thermoplastic polymeric material and even better still of polyvinyl butyral (PVB), said lamination interlayer (single sheet, composite sheet) having a main face FA face-F3 side and a main face FB face-F2 side (in a region offset from, and in particular adjacent to, the in particular OLED or QLED electroluminescent element, said region for example covering at least 50% and even 80% or 90% of the area of the glazing); face FA makes adhesive contact with face F3 (which is bare or coated with a coating) and face FB makes adhesive contact with face F2 (which is bare or coated with a coating), the in particular OLED or QLED electroluminescent element being between faces F2 and F3 and preferably the collimation optic and the asymmetric redirection optic being between faces F2 and F3 or the holographic asymmetric redirection optic is between faces F2 and F3 or the in particular OLED or QLED electroluminescent element is on face F4 and preferably the holographic asymmetric redirection optic is face-F4 side or preferably the collimation optic and the asymmetric redirection optic are face-F4 side.

The lamination interlayer is of thickness E_{A}, between face FA and FB,—which for a motor vehicle—is preferably of at most 1.8 mm, better still at most 1.2 mm and even of at most 0.9 mm (and better still of at least 0.3 mm and even of at least 0.6 mm), in particular set back from the edge face of the first glazing by at most 2 mm and set back from the edge face of the second glazing by at most 2 mm, in particular being an acoustic and/or tinted first sheet.

The lamination interlayer, formed from one or more—front, rear, central . . . —sheets may preferably be made of polyvinyl butyral (PVB), or even of polyurethane (PU), of ethylene/vinyl acetate copolymer (EVA), and for example have a thickness of between 0.2 mm and 1.1 mm. The lamination interlayer may optionally be composite in its thickness as detailed below (PVB/plastic films such as polyester, PET etc./PVB).

It is possible to choose a conventional PVB such as RC41 from Solutia or Eastman.

The lamination interlayer (rear-face and/or front-face and/or central sheet) may comprise at least one what is called central layer made of viscoelastic plastic with vibro-acoustic damping properties, in particular based on polyvinyl butyral (PVB) and plasticizer, and the interlayer, and furthermore comprising two external layers made of standard PVB, the central layer being between the two external layers. Mention may be made, as an example of an acoustic sheet, of the patent EP 0 844 075. Mention may be made of the acoustic PVBs described in the patent applications WO2012/025685, WO2013/175101, in particular tinted as in WO2015079159.

The lamination interlayer may include an acoustic PVB and/or is a PVB that is tinted, said lamination interlayer in particular is a PVB at least partially in its thickness. The tinted portion is at least (and even at most) between the electroluminescent element (OLED, QLED . . . ) and face F3.

A laminated glazing according to the invention may be with:
the first glazing made of mineral glass, the second glazing made of mineral glass that is for example thinner
the first glazing made of mineral glass, the second glazing made of organic glass that is for example thinner (PET, PC, PMMA, etc.) optionally with a protective overlayer on face F4 (‘hard coat’).

The collimation optic and the asymmetric direction optic or the holographic direction optic are for example with the electroluminescent element in the laminate or on face F4. In particular in the case of a laminated glazing (already described):
the collimation optic is larger than the electroluminescent element (OLED, QLED . . . ) and is fastened and preferably adhesively bonded on its periphery by an in particular transparent adhesive or makes on its periphery adhesive contact via its rear face with said lamination interlayer and optionally the redirection optic is larger than the electroluminescent element and is fastened on its periphery and preferably adhesively bonded by an in particular transparent adhesive via its rear face to the collimation optic
or the collimation optic is fastened on its periphery and preferably adhesively bonded by an in particular transparent adhesive to the exit surface and the redirection optic is larger than the electroluminescent element and is fastened on its periphery and preferably adhesively bonded (or even welded) by an in particular transparent adhesive to said lamination interlayer or makes on its periphery adhesive contact (without addition of material) via its rear face with said lamination interlayer (in particular a central sheet, in particular made of PVB).

The electroluminescent element (OLED, QLED . . . ) alone or with the holographic redirection optic or with the collimation optic and the asymmetric redirection optic may have a thickness that is too large to be laminated, via an interlayer sheet or between two interlayer sheets. In particular, the electroluminescent element (OLED, QLED . . . ) may be housed in an aperture of the lamination interlayer and even the collimation optic or even also the asymmetric redirection optic or the holographic redirection optic is housed in said aperture (and even fastened on their periphery for example by adhesive bonding to the electroluminescent element (OLED, QLED . . . ), the aperture is blind with a bottom in the direction of face F3 and opens onto face F2, or the so-called internal aperture is in the thickness of the lamination interlayer and said transparent element is a protective film housed in said internal aperture or larger then said internal aperture and covering said internal aperture.

The aperture is useful in particular when E0 (or E0+E1 if collimation optic or E0+E1 if holographic redirection optic housed or E0+E1+E1 if asymmetric redirection optic housed) is larger than 0.15 mm. The aperture of the lamination interlayer facilitates installation and integration and improves performance.

Completely unexpectedly, in the case of an emergent aperture the interlayer does not flow enough to adversely affect the operation of the optional collimation or redirection optic. In particular, placement under vacuum presses the redirection optic against face F2.

Preferably, the electroluminescent element (OLED, QLED . . . ) and the collimation optic and even the redirection optic (or the holographic redirection optic) are in apertures (preferably) of a PVB or of a PVB/functional film with an optional functional coating/PVB.

Preferably, the glazing has at least one of the following features:
the aperture is in a thickness of PVB (or in one or more sheets, the interface(s) of which are in particular discernible)
the aperture is in an acoustic lamination interlayer, in particular a three-layer or four-layer interlayer
the aperture is in a tinted lamination interlayer
the aperture is in a composite (multisheet) material: PVB/transparent plastic film or even PVB/transparent plastic film/PVB, said plastic film, in particular a polyester film or a film of PET or of another of the already mentioned plastics, being of thickness that is submillimeter-sized and even at most 0.2 mm or at most 0.1 mm bearing a functional coating: providing a low emissivity or solar control function and/or even a heating function.

Naturally, face FB may make direct contact with face F2 or with a conventional functional coating on this face, in particular a stack of thin layers (including one or more silver layers) such as: a heating layer, antennas, a solar-control or low-E layer or a decorative or (opaque) masking layer such as a generally black enamel.

Face FA may make direct contact with the face F3 or with a conventional functional coating on this face, in particular a stack of thin layers (including one or more silver films) such as: a heating layer, antennae, a solar-control or low-E layer or a decorative or (opaque) masking layer such as a generally black enamel.

The glass, preferably the internal glass, which in particular is thin and of thickness smaller than 1.1 mm, is preferably chemically tempered. It is preferably clear. Mention may be made of the examples of patent applications WO2015/031594 and WO2015066201.

The optical films may be fastened together on their periphery, for example adhesively bonded in particular by an adhesive (glue, double-sided adhesive) that is preferably transparent or simply (contact via the apexes of one film on the rear of the other film).

Preferably, regarding the fastening of the collimation optic, the following solutions are preferred:
the collimation optic is fastened (and preferably adhesively bonded or even welded, etc.) to the electroluminescent element (OLED, QLED . . . ), via its rear face, in particular by an adhesive (glue, double-sided adhesive) that is preferably transparent (on the periphery of the exit surface and better still of the emitting surface),
the asymmetric redirection optic is preferably fastened to the collimation optic in particular by a preferably transparent adhesive on the periphery of the final front face
and/or the holographic or asymmetric redirection optic is fastened (and preferably adhesively bonded or even welded, etc.) to the transparent element (protective film, second glazing, or even lamination interlayer etc.), in particular by an adhesive (glue, double-sided adhesive) that is preferably transparent on the periphery of the front face.

An adhesive (glue, double-sided adhesive) that is transparent is preferred if the adhesive is in the vision area. It is possible to choose another fastening means such as a weld (forming a local adhesive contact without addition of material).

In one example of a laminated glazing with a lamination interlayer behind the source, the collimation optic is between face F2 and F3, the electroluminescent element (OLED, QLED . . . ) is between face F2 and F3 and in the zone with the electroluminescent element, face FA makes adhesive contact with face F3 and face FB makes adhesive contact with the entrance surface, the transparent element being the (bare or coated) second glazing.

In one example of a laminated glazing, the electroluminescent element (OLED, QLED . . . ) is between face F2 and F3, and the holographic redirection optic or the collimation optic and the asymmetric redirection optic is between the electroluminescent element and face F2,

and in the zone with the electroluminescent element (OLED, QLED . . . ) face FA makes adhesive contact with face F3 (in particular so-called rear PVB sheet) or on the side of the exit surface (in particular so-called front PVB sheet), and face FB makes adhesive contact with face F2 and the transparent element is a protective film that is plastic, in particular polyester, in particular PET, for example of submillimeter-sized thickness E4, on the final front face, with a face oriented toward face F2 and in adhesive contact with the lamination interlayer and (with a face that is oriented toward face F3 against the final front face while leaving air between the asymmetric prisms or holographic features).

The plastic protective film is optionally local with a so-called extension zone extending beyond the edges of the final front face by at most 10 cm, even by at most 5 cm or 1 cm, in particular with the extension in adhesive contact with the lamination interlayer. The (local or covering) transparent protective film may be a film made of plastic material (organic polymer) and in particular thermoplastic material and preferably made of polyester, polyethylene terephthalate PET, polyethylene PE polycarbonate PC, polymethyl methacrylate PMMA, polystyrene, polyamide, polydimethylsiloxane PDMS, polyethylene naphthalate PEN, polyimide, polyacrylate, polysulfone, polyethersulfone, or (thermoplastic) polyurethane. It is for example of the same material as the collimation and/or redirection film.

The lamination interlayer may be composite and include the following stack outside of the zone of the electroluminescent element (OLED, QLED . . . ): PVB/functional plastic film in particular made of polyester or PET (or one of the other aforementioned plastics) with an optional electrically conductive functional coating face-F2 or face-F3 side/PVB, the functional plastic film, which is preferably of submillimeter-sized thickness E′4, extending over face F2. Furthermore, the electroluminescent element (OLED, QLED . . . ) is between face F2 and F3, between the front face and face F3 is present said plastic film/said PVB, and the transparent element is the functional plastic film on the front face.

The local protective film for example covers at most 20% or at most 10% or 5% of the area of the glazing. In particular, the collimation optic and/or the asymmetric or holographic redirection optic and the front film may be of same size (and even of same size as the electroluminescent element (OLED, QLED . . . ) or set back from the edge face covering at least the active area)) or the area of the front film is larger and preferably extends beyond the edge face of the collimation optic by more than 10 or 5 or 1 cm.

Alternatively, the protective film may cover at least 30%, 50% or 80% to 90% of face F2 or (for example set back by at most 5 cm, 1 cm, or 5 mm from the edge face of the first glazing). Preferably it bears a low-emissivity or solar-control and/or even heating functional coating, in particular covering at least 80% or 90% of face F2.

With respect to the location of the electroluminescent element (and its collimation optic):
face F2 may be free, the glazing is monolithic for example made of glass, PMMA, PC, and the asymmetric or holographic redirection optic is on face F2 or if the glazing is laminated and the asymmetric or holographic redirection optic is on the free face F4,
the collimation optic is fastened on its periphery, in particular by adhesive bonding, to the electroluminescent element, via its rear face, in particular by a preferably transparent adhesive (glue, double-sided adhesive) on the periphery of the exit surface and/or the assembly consisting of the electroluminescent element/collimation optic/asymmetric redirection optic or of the electroluminescent element/holographic redirection optic is fastened, in particular by adhesive bonding, preferably by a preferably transparent adhesive (glue, double-sided adhesive) to the free face F4 or F2 via a rear protective film (tacky, etc.) that is on the entrance surface of said electroluminescent element with a fastening portion extending onto the free face F4 or F2.

The rear protective film may have another function. It may be tinted, and/or bear an electrically conductive (solar-control, low-E, etc.) coating in particular covering at least 80% or 90%.

The rear protective film in particular covering at least 80% or 90% of face F2 may be composite via a PET with a protective overlayer (so-called “hard coat”).

In the case of fastening to a free face F2 or F4, in order to avoid extra thickness on the free face F2 or F4, E0 is of at most 1 mm and even of at most 0.5 mm. Preferably, the thickness of the assembly consisting of the electroluminescent element (such as an OLED or QLED)/collimation optic/asymmetric redirection optic or the thickness of the assembly consisting of the electroluminescent element (such as an OLED or QLED)/holographic redirection optic is of at most 1 mm and even 0.9 mm.

Preferably when the electroluminescent element is between faces F2 and F3, in order to avoid an extra thickness of lamination interlayer, E0 is of at most 1 mm and even of at most 0.5 mm.

Whatever its location (on free face F2 or F4 or between F2 and F3 of a laminated glazing) the electroluminescent element (such as an OLED or QLED) may be local and for example cover at most 20% or at most 10% or even at most 5% of the area of the glazing and/or the collimation optic may be local and for example cover at most 20% or at most 10% or 5% of the area of the glazing.

In particular, the electroluminescent element (such as an OLED or QLED), the collimation optic and/or the redirection optic may be of the same size or set back from the edge face (covering at least the active area) or the area of the collimation optic and/or the redirection optic is larger and preferably does not extend beyond the edge face of the electroluminescent element by more than 10 or 5 or 1 cm.

The (rear) protective film may be local and for example cover at most 20% or at most 10% or 5% of the area of the glazing. In particular, the collimation optic, the redirection optic and the rear film may be of same size (and even of same size as the electroluminescent element or set back from the edge face covering at least the active area) or the area of the rear film is larger and preferably does not extend beyond the edge face of the collimation optic and redirection optic by more than 10 or 5 or 1 cm.

Alternatively, the (rear) protective film may cover at least 30%, 50%, 60% or 90% of face F2 (for example set back by at most 5 or 1 cm or 5 mm from the edge face of the first glazing). For example, it bears a low-emissivity or solar-control and/or even heating functional coating.

An element for electrically connecting said electroluminescent element may be connected to said electroluminescent element and extend beyond the edge face of the glazing.

An electrically connecting element that is preferably flexible may be fastened (adhesively bonded, welded, etc.) or pressed against the electroluminescent element, the electrically connecting element preferably extending beyond the edge face of the glazing. It is for example of thickness that is of at most 0.2 mm or of at most 0.15 mm and even of at most 0.1 mm.

The electrically connecting element (strip or wires) may be connected to the electroluminescent element in one (or more than one) peripheral zone of the entrance or exit surface.

In one embodiment, the electrically connecting element is an assembly of two metal wires or metal strips.

In one embodiment, the electrically connecting element is a strip (flat connector) that includes a film made of a preferably transparent plastic material, preferably polyester, polyethylene terephthalate or PET or of polyimide, provided with conductive tracks that are in particular metal (copper etc.) or made of transparent conductive oxide.

The conductive tracks are printed or deposited by any other deposition method, for example physical vapor deposition. The conductive tracks can also be wires. It is preferable for the conductive tracks and the film to be transparent when they are visible, that is to say when they are not masked by a masking element (layer) (such as an enamel, indeed even a paint, and the like), in particular on face F4 or F3. The conductive tracks can be transparent due to the transparent material or due to their width being sufficiently thin to be (virtually) invisible.

Polyimide films have a higher temperature withstand than alternative PET or even PEN (polyethylene naphthalate) films.

The electrically connecting element may be (entirely or partially) in the vision area of the roof and optionally spaced apart from opaque peripheral strips (even forming an opaque frame), such as strips of a (black, dark, etc.) masking enamel. Most often, there is an opaque layer on face F2 and an opaque layer on face F4, indeed even F3. Their widths are identical or distinct.

The width Li of an opaque peripheral strip on face F2 and/or F3 and/or F4 is preferably at least 10 mm and even 15 mm. Thus, the length of the electrically connecting element may be larger than Li.

The electrically connecting element may be arranged in or in the vicinity of the region of an opaque layer, in particular a (black) enamel, along a peripheral edge of the laminated glazing, generally on face F2 and/or face F4 or also on face F2 and/or on face F3.

Thus, in a first embodiment, the electrically connecting element may even be located in a region of the glazing, in which region the exterior glass is entirely (or partially) opaque because of the presence of an opaque layer (the most external opaque layer), such as a layer of (black) enamel, on F2. This opaque layer may, in this region of the glazing, be an unapertured layer (continuous background) or a layer with one or more discontinuities (areas without opaque layer), said layer for example taking the form of a set of optionally geometric (circular, rectangular, square etc.) features that are of identical or distinct size (of size that decreases with distance from the edge face and/or the features getting further and further apart with distance from the edge face).

In this first embodiment, the electroluminescent element, such as the OLED or QLED, and the electrically connecting element may be visible only from the interior and therefore masked by the opaque layer on face F2.

The electrically connecting element may be placed in a region of the glazing, in which region the interior glass is opaque because of the presence of an opaque layer (the most internal opaque layer), such as a layer of (black) enamel, preferably on F4 or even on F3. The electroluminescent element, such as the OLED or QLED, may be placed in this region of the glazing, this opaque layer then includes an aperture (produced via a mask during deposition or by removal in particular with a laser) plumb with the electroluminescent element.

The electroluminescent element is suitably placed in the front as in the rear of the vehicle for example along a longitudinal or lateral edge of the glazing. A reading light facing each seat is preferred.

In case of a plurality of electroluminescent elements, they may be connected in series or in parallel and/or independently. Two electroluminescent elements may be on a common element that serves for the electrical connection.

Two electroluminescent elements may be separated and connected together by an electrically connecting element that preferably is as discreet as possible, for example wires or a transparent flat connector.

In one embodiment of the vehicle, it includes at least one control unit for driving the electroluminescent element (such as an OLED or QLED) and even at least one sensor, in particular for detecting luminosity. A control unit for driving the (each) electroluminescent element (OLED or QLED) may be in the laminated glazing or on the glazing.

In order to limit heating of the passenger compartment or to limit the use of air conditioning, the first glazing or one of the glazings at least (preferably the exterior glass) is tinted. Furthermore, the glazing, which is in particular laminated, may also include a layer that reflects or absorbs solar radiation, preferably on face F4 or on face F2 or F3, in particular a layer of transparent electrically conductive oxide, i.e. what is called a TCO layer, or even a stack of thin layers comprising at least one TCO layer, or stacks of thin layers comprising at least one silver layer (on F2 or preferably F3 for a laminated glazing), the or each silver layer being placed between dielectric layers.

It is possible to simultaneously have a (silver-containing) layer on face F2 and/or F3 and a TCO layer on face F4.

The TCO layer (of a transparent electrically conductive oxide) is preferably a layer of fluorine-doped tin oxide (SnO₂:F) or a layer of mixed indium tin oxide (ITO).

Other layers are possible, including thin layers based on mixed indium zinc oxides (referred to as “IZOs”), based on gallium-doped or aluminum-doped zinc oxide, based on niobium-doped titanium oxide, based on cadmium or zinc stannate, or based on antimony-doped tin oxide. In the case of aluminum-doped zinc oxide, the doping level (that is to say, the weight of aluminum oxide with respect to the total weight) is preferably less than 3%. In the case of gallium, the doping level can be higher, typically within a range extending from 5 to 6%.

In the case of ITO, the atomic percentage of Sn is preferably within a range extending from 5 to 70% and in particular from 10 to 60%. For layers based on fluorine-doped tin oxide, the atomic percentage of fluorine is preferably at most 5% and generally from 1 to 2%.

ITO is particularly preferred, especially with respect to SnO₂:F. Of higher electrical conductivity, its thickness can be smaller to obtain one and the same emissivity level. Easily deposited by a cathode sputtering process, in particular a magnetron cathode sputtering process, these layers are characterized by a lower roughness and thus a lower tendency to foul.

One of the advantages of fluorine-doped tin oxide is, on the other hand, its ease of deposition by chemical vapor deposition (CVD), which, contrary to the cathode sputtering process, does not require a subsequent heat treatment and can be implemented on the float plate-glass production line.

The term “emissivity” is understood to mean the normal emissivity at 283 K within the meaning of the standard EN12898. The thickness of the low-emissivity (TCO, and the like) layer is adjusted, depending on the nature of the layer, so as to obtain the desired emissivity, which depends on the sought-after thermal performance qualities. The emissivity of the low-emissivity layer is, for example, less than or equal to 0.3, in particular less than or equal to 0.25 or even less than or equal to 0.2. For layers made of ITO, the thickness will generally be at least 40 nm, indeed even at least 50 nm and even at least 70 nm, and often at most 150 nm or at most 200 nm. For layers made of fluorine-doped tin oxide, the thickness will generally be at least 120 nm, indeed even at least 200 nm, and often at most 500 nm.

For example, the low-emissivity layer comprises the following sequence: high-index underlayer/low-index underlayer/a TCO layer/optional dielectric overlayer.

It is possible to choose, as preferred example of low-emissivity layer (protected during a tempering), high-index underlayer (<40 nm)/low-index underlayer (<30 nm)/an ITO layer/high-index overlayer (5-15 nm)/low-index barrier overlayer (<90 nm)/final layer (<10 nm).

Mention may be made, by way of low-emissivity layer, of those described in the patent US2015/0146286, on face F4, in particular in examples 1 to 3.

In a preferred embodiment:
the first and/or second glazing is tinted and/or the lamination interlayer is tinted over all or some of its thickness
and/or one of faces F2 or F3 or F4—preferably face F4—of the glazing is coated with a low-emissivity layer, in particular comprising a transparent electrically conductive oxide layer (“TCO layer”), in particular a stack of thin layers with a TCO layer or a stack of thin layers with silver layer(s)
and/or one of faces F2 or F3 or F4—preferably face F3—of the glazing is coated with a solar-control layer, in particular one comprising a transparent electrically conductive oxide layer (i.e. what is called a TCO layer) and in particular a stack of thin layers containing a TCO layer or a stack of thin layers containing one or more silver layers
and/or an additional tinted (polymeric, such as a polyethylene terephthalate PET, and the like) film is between faces F2 and F3 or (bonded) on F4, indeed even on face F1.

In particular, face F4 of the glazing is coated with an in particular low-emissivity transparent functional layer that preferably comprises a TCO layer.

The invention of course relates to any vehicle and in particular to an automobile including at least one glazing such as described above.

The invention also aims to achieve greater simplicity and/or to increase rates.

To this end, one subject of the invention is a manufacturing process including, before installation on the first glazing (for example by adhesive bonding via a rear protective plastic film for example on face F2 of the monolithic glazing or F4 of a laminated glazing—or by peripheral bonding of the last optical or protective film to face F2 of the monolithic glazing or F4 of a laminated glazing—or between two glazings of a laminated glazing) pre-mounting, on the electroluminescent element (OLED, QLED, etc.), on its exit surface:
the film-based collimation optic and even the film-based prismatic redirection optic, in particular by peripheral fastening and even by peripheral bonding that optionally forms a seal, and in particular by peripheral fastening and even by peripheral bonding that optionally forms a seal
or the film-based holographic redirection optic, in particular by peripheral fastening and even by peripheral adhesive bonding optionally forming a seal
and even optionally an optionally colored protective film on the last redirection optical film, in particular by peripheral fastening and even by peripheral adhesive bonding optionally forming a seal.

Preferably, all are fastened and even adhesively bonded peripherally so as to optionally form a seal.

To this end, the invention also proposes a process for manufacturing a luminous laminated glazing, for example a laminated glazing such as described above, that includes the following steps:
positioning the electroluminescent element, in particular the OLED, on (or even fastening to, in particular by adhesive bonding preferably with a transparent adhesive or by creating adhesive contact by spot heating, etc.) an unapertured lamination interlayer sheet or in a through- or blind aperture and simultaneously or separately positioning the collimation optic and the asymmetric redirection optic or the holographic redirection optic facing the electroluminescent element
   and successively:
installing the assembly positioned between the first and second glazing
laminating under vacuum and with heating or even under pressure (and with heating), autoclaving for example.

Thus operations are carried out off the industrial lamination line.

The process may furthermore comprise or make provision:
for the electroluminescent element and in particular the OLED to be positioned on said lamination-interlayer sheet in a through- or blind aperture entrance-surface side, with the holographic redirection optic or with the collimation optic or even indeed the asymmetric redirection optic housed in the aperture and fastened, and preferably adhesively bonded, on the periphery of the exit surface or with the asymmetric or holographic redirection optic capping the aperture and on said lamination-interlayer sheet capping the aperture and on said lamination-interlayer sheet
before said positioning, for a local protective film to be fastened, in particular by adhesive bonding, to the final front face of the holographic or asymmetric redirection optic and during said positioning for said lamination interlayer to have a blind hole housing the local protective film or said lamination interlayer to have a through-hole and another lamination interlayer to close the hole
for said lamination interlayer to have a through-hole housing the electroluminescent element in particular the OLED, and the collimation optic and the asymmetric redirection optic or the electroluminescent element and the holographic redirection optic, the process including placing a protective film closing the hole and another interlayer sheet covering the protective film optionally already in adhesive contact with the protective film
for point adhesive contact to be created by heating and pressure outside of the zone of the electroluminescent element, in particular the OLED
   between said interlayer sheet and another so-called rear interlayer sheet entrance-surface side
   and/or between said interlayer sheet and another so-called front interlayer sheet exit-surface side,
   and/or between the collimation optic and the asymmetric redirection optic or the holographic redirection optic and the interlayer sheet or another interlayer sheet
the electroluminescent element and even the collimation optic and the asymmetric redirection optic or the electroluminescent element and the holographic redirection optic being in a through- or blind hole of one of said interlayer sheets and/or the electroluminescent element and even the collimation optic and the asymmetric redirection optic or the electroluminescent element and the holographic redirection optic being sandwiched between said interlayer sheet and the front or rear other interlayer sheet.
for said (unapertured or apertured) interlayer sheet to be an optionally acoustic PVB sheet or to be a composite (whether preassembled or not) PVB/functional plastic film or PVB/functional plastic film/PVB, the positioning being carried out on the PVB or on the functional film, the functional film preferably being unapertured when the PVB is apertured.

Preferably, before the lamination, the through—or blind hole is of thickness Eₜ of 0.3 to 0.9 mm with an absolute value E1-Et of at most 0.3 mm or Ei—sum of the OLED and optic(s) thicknesses of at most 0.3 mm.

The following may preferably be used:
a first and only sheet with a blind hole, preferably optionally acoustic PVB
a first (PVB) sheet with a through- and blind hole and a second unapertured (PVB) sheet,
a first (PVB) sheet with a through- and blind hole between a second unapertured (PVB) sheet and a third unapertured (PVB) sheet.

In particular:
the rear sheet F3-side is of optionally acoustic and/or tinted PVB of 0.3 to 0.9 mm thickness Eᵢ
and/or the central sheet with through- or blind hole is of optionally acoustic and/or tinted PVB of 0.3 to 0.9 mm thickness Eⱼ with an absolute value E1−E2 of at most 0.3 mm—
and/or the front sheet F2-side is of clear or extra-clear and optionally acoustic PVB of 0.3 to 0.9 mm thickness Eₖ.

The creation of local adhesive contact allows the elements to remain securely fastened to one another during the rest of the process.

Provision is optionally also made to create local adhesive contact between the assembly and at least one of the first and second glazings.

Each adhesive contact is for example of width of at most 15 mm.

In particular and advantageously, the local adhesive contact is created by local heating of the lamination interlayer (from 60° to 80° C. for PVB) and better still by applying pressure.

The local heating is in particular by induction, hot air, heating element, by radiation (laser etc.).

By way of heating tool (and better still pressure-applying tool) a “soldering iron” with a flat end-fitting (with a (silicone, PTFE elastomer etc.) non-stick coating able to let the heat pass), heating fingers or a hot-air gun may be used.

A heating tool that allows the various point adhesive spots to be produced in a single operation may be chosen.

The local protective film may be:
adhesively bonded on the periphery of the redirection optic
adhesively bonded beforehand to the rear face of the PVB before point adhesive contact is created preferably by heating
adhesively bonded to the face of a central PVB with an aperture for the electroluminescent element, which is in particular an OLED, and by creation of point adhesive contact preferably by heating.

The covering protective film may be:
adhesively bonded beforehand to the rear face of the PVB before point adhesive contact is created preferably by heating
adhesively bonded to the face of a central PVB with an aperture for the electroluminescent element, which is in particular an OLED, by creation of point adhesive contact preferably by heating.

The process may comprise providing what is called a central PVB sheet or a composite sheet consisting of a PVB/functional plastic film such as a PET film bearing an optional functional coating or of a PVB/functional plastic film such as a PET film bearing an optional functional coating/PVB, with a through-aperture housing, pre-lamination, the electroluminescent element, in particular the OLED, and optionally the collimation optic being adhesively bonded to the exit surface on its periphery. The process may comprise creating local adhesive contact between the central sheet and the rear or front sheet and/or the electroluminescent element, which is in particular an OLED.

Conventionally the lamination includes degassing, and sometimes autoclaving, which implies the implementation of suitable temperatures and pressures; conventionally, during the autoclaving, the sheet, such as the PVB, is brought to a relatively high temperature (higher than 100° C. for PVB), thereby softening it and allowing it to flow. In the case of use of a plurality of in particular PVB sheets, a noteworthy effect then occurs; the interfaces of the various PVB sheets will disappear; the PVB will, so to speak, scar to form, at the end of the autoclave, a continuous and uniform film.

The lamination, which may influence the width of the potential aperture, is achieved by reflow of the interlayer. By reflow, the lamination interlayer (first sheet, leaf or composite sheet) with the aperture larger than the electroluminescent element and even than the collimation optic.

Each sheet is preferably dimensioned to cover at least 80% or 90% of face F2, and could extend beyond face F2.

Each sheet is preferably of PVB.

The present invention will now be described in greater detail with reference to the appended figures, in which:

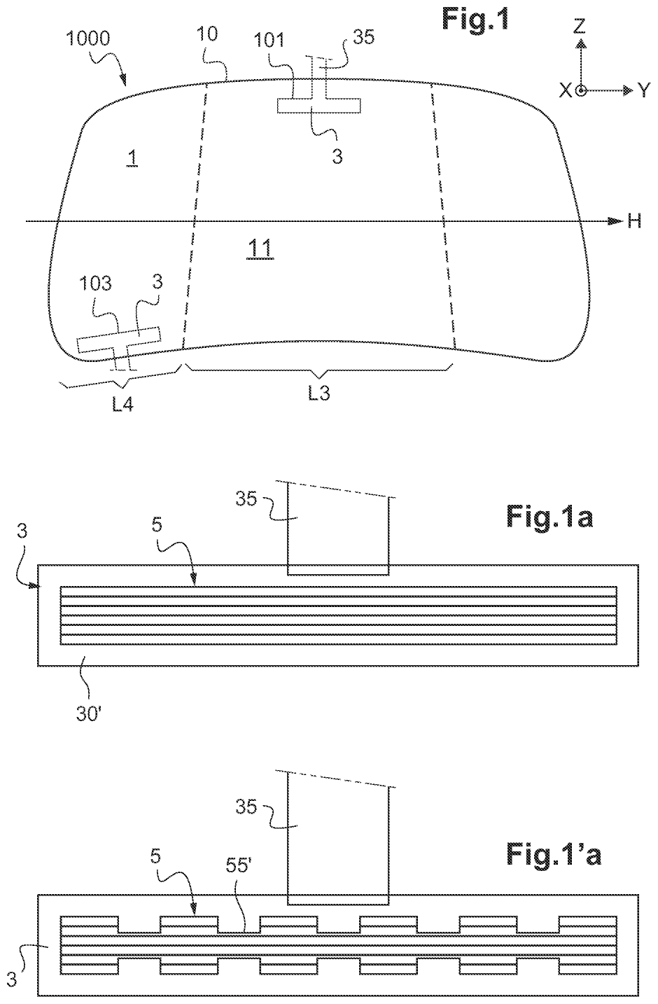

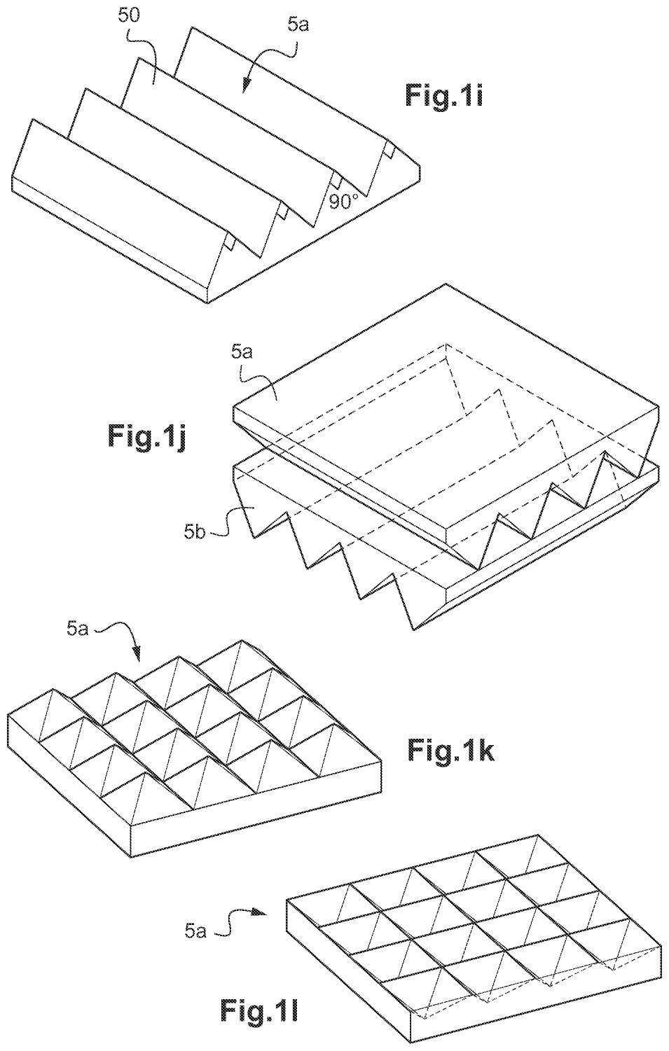

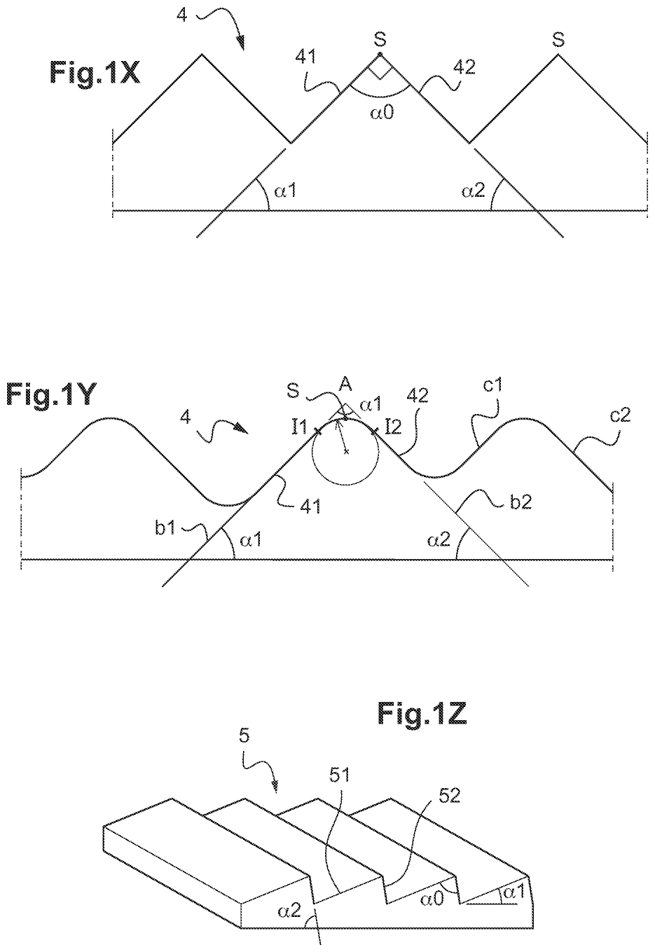

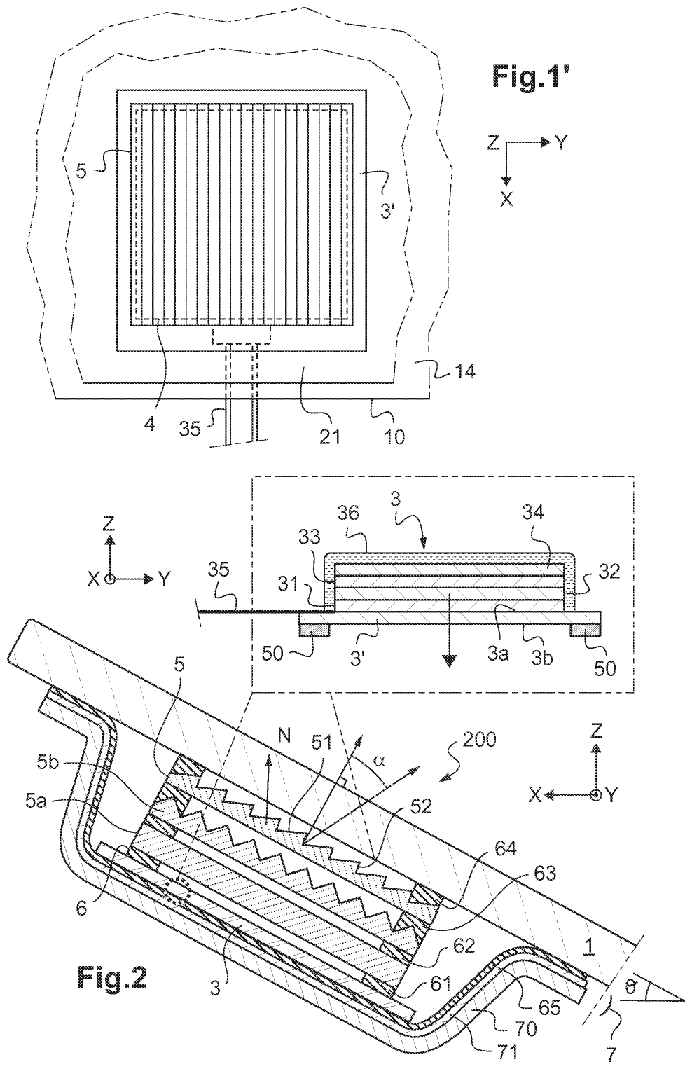

FIG. 1 is a face-on view face-F1 side of a rear window with the OLED providing collimated and redirected light according to the invention.

FIG. 1a is a face-on detail view of the OLED equipped with its collimation optic and redirection optic.

FIG. 1′a is an alternative exterior-side face-on detail view of OLED equipped with its collimation optic and redirection optic.

FIG. 1′ is an exterior-side face-on detail view of the OLED with a collimation and redirection optic.

FIG. 1i is an overview of a collimation optic.

FIG. 1j is an overview of a collimation optic.

FIG. 1k is an overview of a collimation optic.

FIG. 1l is an overview of a collimation optic.

FIG. 1X is an overview of a collimation optic.

FIG. 1Y is an overview of a collimation optic.

FIG. 1Z is a face-on view of a collimation optic.

FIG. 2 is a cross-sectional view of a rear window (back window) according to a second embodiment.

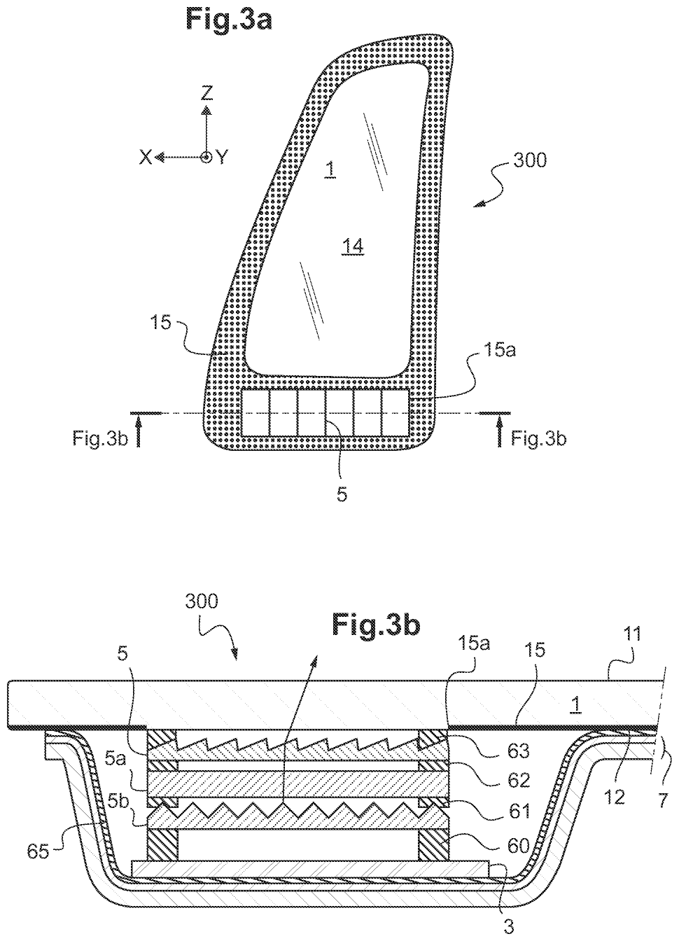

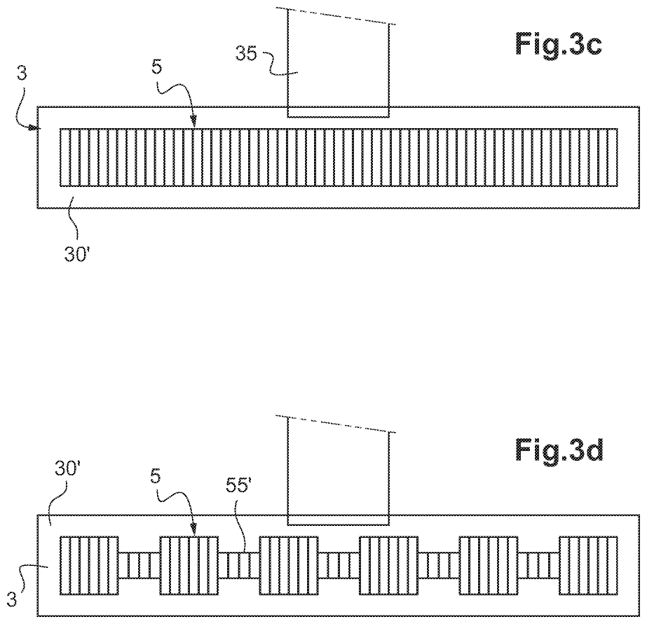

FIG. 3a is a face-on view of a deflector (fixed side window) with OLED providing collimated and redirected light according to the invention.

FIG. 3b is a cross-sectional view of a deflector (fixed side window) with OLED providing collimated and redirected light according to the invention.

FIG. 3c is a face-on detail view of OLED equipped with its collimation optic and redirection optic.

FIG. 3d is an alternative face-on detail view of OLED equipped with its collimation optic and redirection optic.

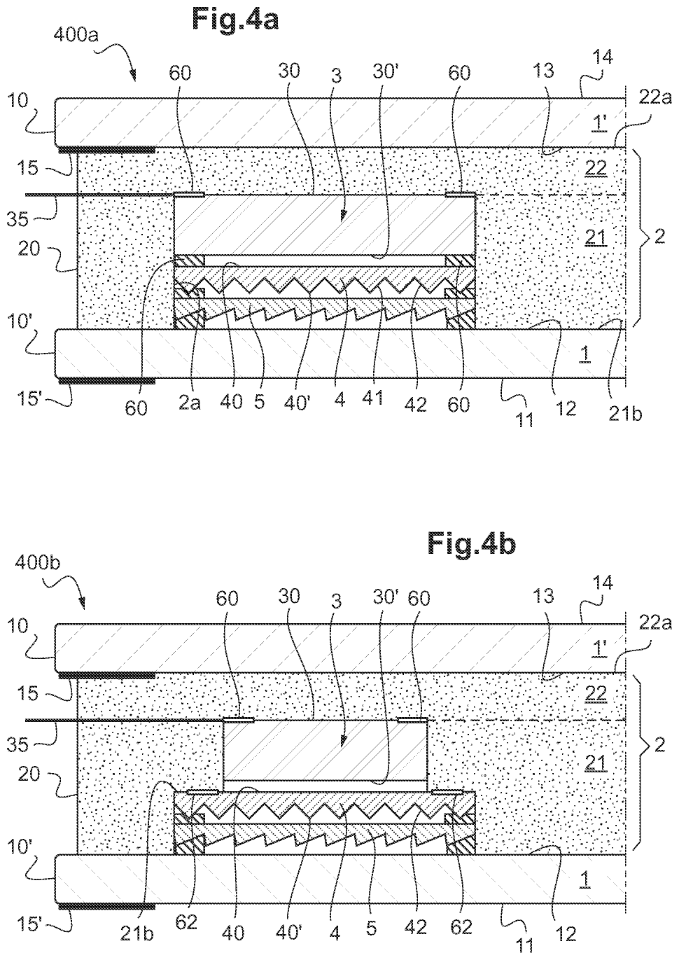

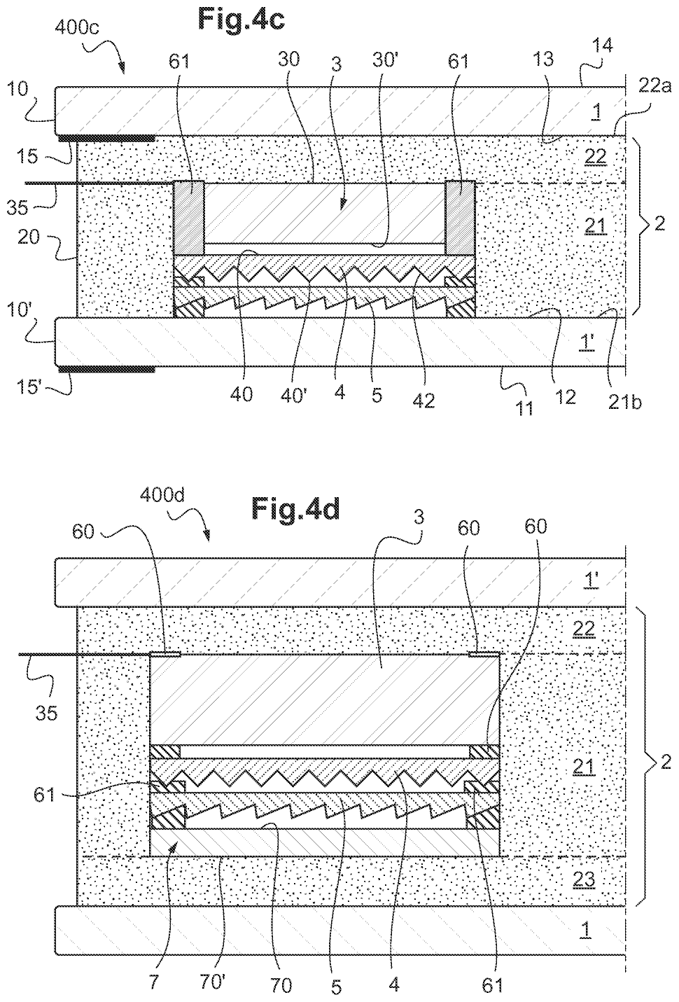

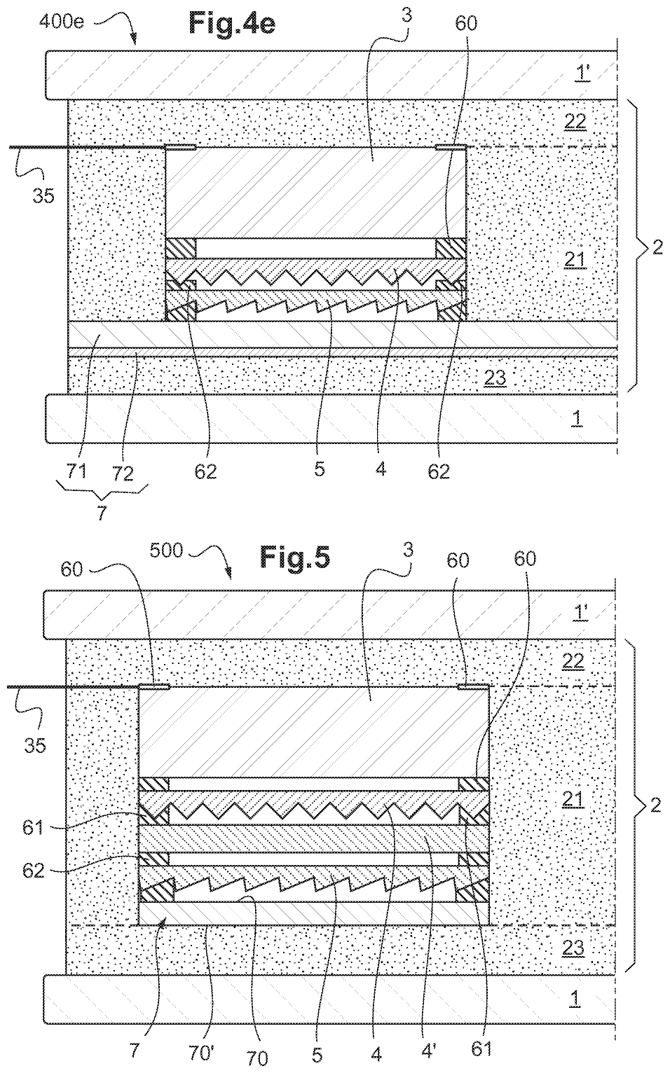

FIG. 4a is a cross-sectional view of a glazing 400a (back window or deflector) providing collimated and redirected light according to the invention.

FIG. 4b is a cross-sectional view of a glazing 400b (back window or deflector) providing collimated and redirected light according to the invention.

FIG. 4c is a cross-sectional view of a glazing (back window or deflector) providing collimated and redirected light according to the invention.

FIG. 4d is a cross-sectional view of a glazing (back window or deflector) providing collimated and redirected light according to the invention.

FIG. 4e is a cross-sectional view of a glazing (back window or deflector) providing collimated and redirected light according to the invention.

FIG. 5 is a cross-sectional view of a glazing with the OLED providing collimated and redirected light according to the invention.

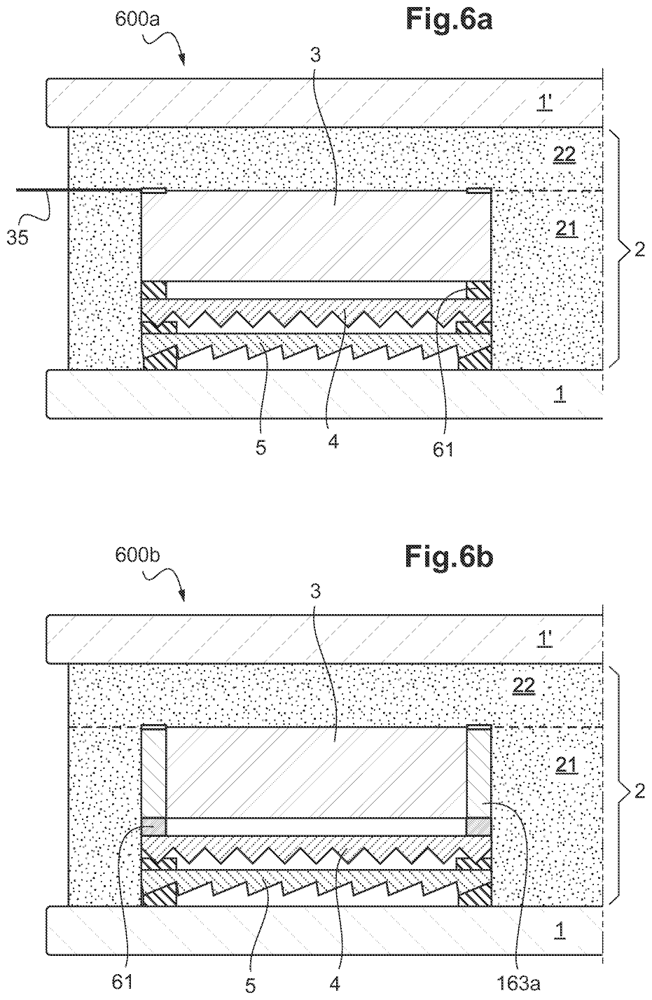

FIG. 6a is a cross-sectional view of a glazing (back window or deflector) with the OLED providing collimated and redirected light according to the invention.

FIG. 6b is a cross-sectional view of a glazing according to the invention with the OLED providing collimated and redirected light according to the invention.

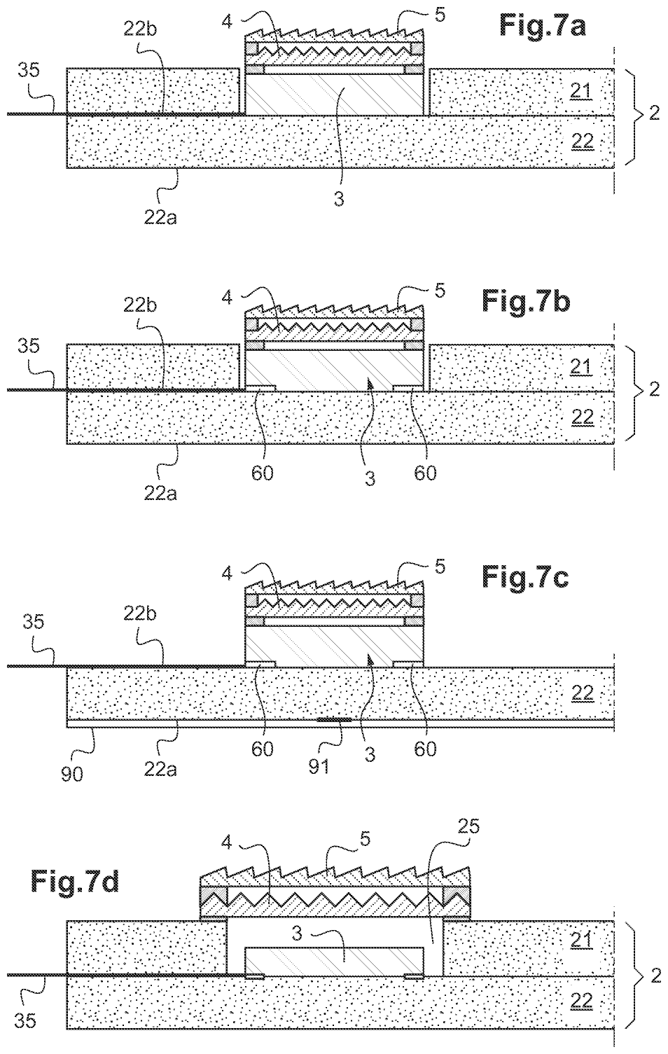

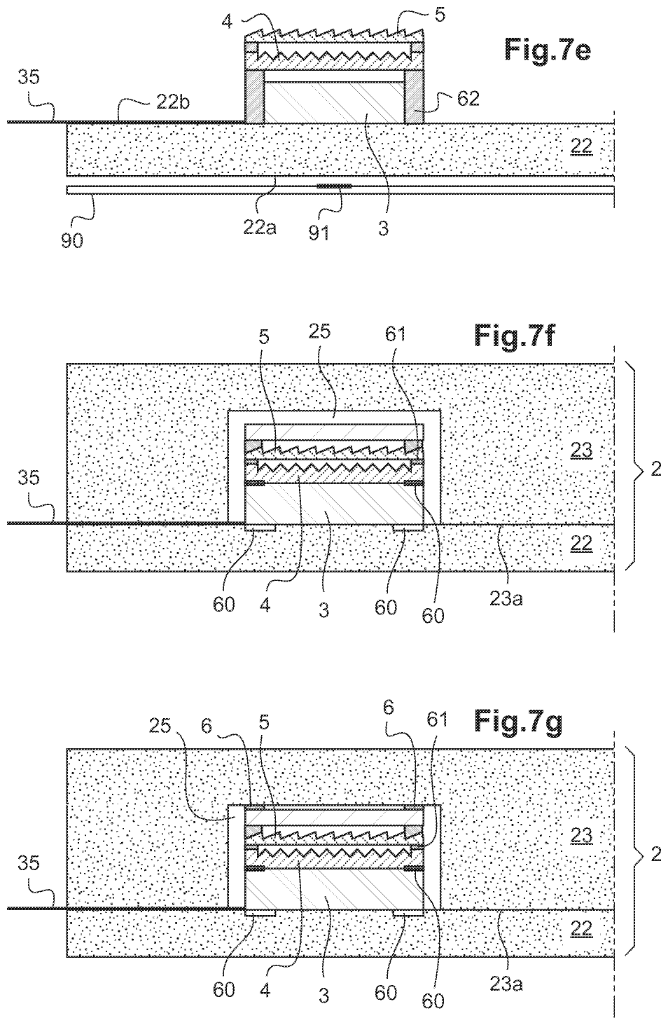

FIG. 7a is a view showing a step of mounting, not during lamination, the OLED with the collimation and redirection optic on a first PVB lamination-interlayer sheet with the aim of producing the glazing according to the invention.

FIG. 7b is a view showing a step of mounting, not during lamination, the OLED with the collimation and redirection optic on a first PVB lamination-interlayer sheet with the aim of producing the glazing according to the invention.

FIG. 7c is a view showing a step of mounting, not during lamination, the OLED with the collimation and redirection optic on a first PVB lamination-interlayer sheet with the aim of producing the glazing according to the invention.

FIG. 7d is a view showing a step of mounting, not during lamination, the OLED with the collimation and redirection optic on a first PVB lamination-interlayer sheet with the aim of producing the glazing according to the invention.

FIG. 7e is a view showing a step of mounting, not during lamination, the OLED with the collimation and redirection optic on a first PVB lamination-interlayer sheet with the aim of producing the glazing according to the invention.

FIG. 7f is a view showing a step of mounting, not during lamination, the OLED with the collimation and redirection optic on a first PVB lamination-interlayer sheet with the aim of producing the glazing according to the invention.

FIG. 7g is a view showing a step of mounting, not during lamination, the OLED with the collimation and redirection optic on a first PVB lamination-interlayer sheet with the aim of producing the glazing according to the invention.

The figures are not to scale and are schematic.

All of the figures illustrate, by way of light source, an OLED, but, as a variant, a QLED or TFEL may be chosen. All of the figures illustrate a collimation optic and a redirection optic obeying the laws of geometric optics. Cumulatively or alternatively to the change of source, it is possible to substitute for the asymmetric redirection optic (and for the collimation optic) a holographic redirection optic. The deviation angle will depend on the pitch and on the wavelength of the light.

FIG. 1 is an exterior-side face-on view of a rear window 1000 with two example OLEDs providing collimated and redirected light according to the invention and therefore light in the direction of exterior face F1 11 of the first, for example monolithic, glass sheet 1.

The following are shown:
a first OLED 3 or series of OLEDs providing MV red light that is collimated and redirected by optics 5 (collimation optic and thereabove the redirection optic 5, which redirects toward the ground) along the upper edge and centered in a rectangular strip in order to form a third stoplight 101 (zone L3)
a second OLED 3 or series of OLEDs providing MV yellow light that is collimated and redirected by optics 5 (collimation and redirection 5 toward the ground) along the lower edge and off-centered in a rectangular strip in order to form an indicator side-repeater light 103 (zone L4).

The OLEDs are supplied with power by a connector 35 that extends beyond the edge of the glass and optionally the latter is masked from the exterior by a peripheral masking layer that is in particular made of black enamel (layer not shown) on face F2. As a variant, the OLEDs may form a pictogram.

FIG. 1a is a face-on detail view of the OLED 3 (one or more side-by-side or separate OLEDs that are for example each rectangular) equipped on the side of the exit surface 30′ with its collimation optic made up of an array of prisms extending along the horizontal H, which optic is surmounted by the redirection optics 5 made up of an array of asymmetric prisms extending along the horizontal H.

Thin and transparent optical films that are for example each of rectangular shape and in particular a stack of two or three or more films is preferred.

FIG. 1′a is an alternative face-on detail view of a plurality of side-by-side OLEDs 3 (for example each is square or rectangular) equipped with their collimation optic and redirection optics 5. Between the OLEDs the optics (non-functional portions 55′) may be of small width or even of zero width or without texture. For each optic, one or more thin and transparent optical films, for example of rectangular shape (constant or small width between the OLEDs as mentioned above), and in particular a stack of two or three or more films, is preferred.

FIG. 1i is an overview of a collimation optic according to the invention. FIG. 1x is a cross-sectional view of a collimation optic with pointed apexes S and angles representative of the angle prisms at the apex, angle to plane of the prismatic optical film).

The collimation optic 5a is here a prismatic optical film that will for example be fastened on its periphery by a double-sided adhesive or a glue to the exit surface (generating an air-filled cavity entry-side) of the OLED. It is for example an example plastic film of less than 0.3 mm thickness and made of PET that is partially textured in its thickness. It includes in its front face an array of preferably contiguous and even symmetric prisms 50 with apexes S and with a pitch T between the apexes that is from 10 μm to 500 μm, extending longitudinally along an axis making an angle of at most 10° to the reference direction (here the horizontal for the back window or as a variant a windshield), and even parallel.

Each prism is defined by two longitudinal faces 41, 42, each prism has an angle at the apex ranging from 60 to 110°, better still of 90° and each longitudinal face makes to the plane of the optical film 4 an angle ranging from 30 to 55° and better still of 45°.

For example, the pitch is 160 μm and the height 80 μm and the remaining thickness is 175 μm with angle at the apex and valley side of 90° (+−20 arc).

Air is between the exit surface of the OLED and the entrance face of this single optical film 5a of the collimation optic.

Air is between the prisms of the front face of the collimation optic; the apexes of the features of each front face make physical contact with face F2.

FIG. 1′ is a face-on exterior-side detail view of the OLED with the collimation optic and redirection optic 5 adhesively bonded on its periphery for example facing technical edges (on the carrier 3′) of the OLED 3. The longitudinal axis of the prisms is the horizontal between the sides of the back window (or windshield).

The adhesive bonding may be frame-like and form a seal.

FIG. 1Y is an overview of another collimation optic 4 according to the invention.

This figure differs from FIG. 1X in that the apexes are rounded and the lateral faces curved; the angles representative of the prisms (angle at the apex, angle to the plane of the film) are defined on the basis of two straight lines b1, b2 that are secant in A, passing through the inflection points I1, I2. The radius of curvature is also limited.

FIG. 1j is an overview of a collimation optic according to the invention.

This figure differs from FIG. 1i in that to form the collimation optic an identical second prismatic film 5b that is crossed at 90° and for example adhesively bonded (welded, etc.) on its periphery to the first prismatic film 5a has been added.

FIG. 1k is an overview of a collimation optic.

This figure differs from the preceding figure in that the collimation optic 4 (again a plastic film that is partially textured in its thickness, for example a film made of PET of less than 0.6 mm thickness) bears two-dimensional features.

Each two-dimensional feature being defined by a flank e and in a plane P normal to the film 5a each two-dimensional feature has an angle at the apex ranging from 60 to 110°, each intersection of the flank with the plane P making with the plane of the film an angle ranging from 30 to 55°. Preferably, an angle at the apex (in the plane P) of 90° is chosen and the 2 other angles are chosen to be 45°.

The two-dimensional features are here raised, the apexes of the features of each front face are free or make physical contact with a transparent element (face F2 of the exterior glazing for example), and air is between the two-dimensional features.

FIG. 1l is an overview of a collimation optic according to the invention.

This figure differs from the preceding figure in that here the two-dimensional features are recessed, the array of two-dimensional features is an array of cavities, the apexes S are oriented (toward the interior of the passenger compartment (toward face F3 of a laminated glazing)) and the top surface of each cavity is free or makes physical contact with a transparent (second glazing, etc.) element and air is in the cavities.

Once the light has been collimated it is necessary to redirect it toward the ground for the back window (or toward the rear for a rear window, etc.).

FIG. 1Z is a face-on view of a redirection optic that will be on the front face of the collimation optic (fastened to its periphery, for example by adhesive bonding or welding or spaced apart therefrom by at most 1 mm). It is a redirection optical film including an array of asymmetric prisms with apexes and with a pitch T′ between apexes that is from 10 μm to 500 μm, with preferably at least 4 or even 10 features facing the exit (or light-emitting) surface.

The redirection optic thus includes a first optical film 5 that is asymmetric prismatic with, on a main face opposite to the exit surface, called the final front face, said array of asymmetric prisms extending longitudinally along a third axis making an angle of at most 10°, at most 5° or at most 2° to said first axis and even parallel and/or to the reference direction of the glazing (the horizontal for the back window) and even is parallel, in particular with a submillimeter-sized thickness.

Each asymmetric prism is defined by first and second longitudinal faces, the prism preferably having a length L and a width W with L>2W and better still L>5W or L>10W. Each asymmetric prism has an angle at the apex a′0 ranging from 50 to 60° better still of 55°±5° or 55°±2° and the first longitudinal face 51 (called the long side) makes to the plane of the film a first angle, ranging from 31 to 41° better still of 35°±5° or 35°±2° (naturally the second longitudinal face 52 (called the short side) makes to the plane of the film a second angle, ranging from 79 to 99° better still from 85 to 90° or 88 to 90°, and preferably of at most 90°). Preferably, the difference a4−a3 is larger than 40° and even than 50°.

As a variant, an assembly consisting of two parallel optical films that are asymmetric prismatic is chosen.

FIG. 2 is a cross-sectional view of a monolithic rear window (back window) with OLED providing collimated and redirected light according to the invention according to one embodiment.

This back window 200 comprises a transparent first glazing 1 made of organic or mineral glass, with main faces 11, 12 called faces F1 and F2, and an edge face 0, and a so-called reference direction that is the horizontal in the plane of the (optionally curved) glazing.

The OLED 3 emits MV red toward face F2 and has an emitting area of length of at least 5 cm and of width of at least 1 cm, and is preferably of submillimeter-sized thickness E0, with an emission half angle at the apex of 50° to 70° and a main emission direction normal to the plane of said OLED.

To the exit surface of the OLED is fastened by peripheral adhesive bonding 61 a first optical film 5a with said array of prisms extending longitudinally along a first axis.

To the front face of this first film is fastened by peripheral adhesive bonding 62 a second optical film 5b with the second array of prisms extending longitudinally along a second axis making an angle to said first axis of 90°; the first or second axis makes to the reference direction a zero angle.

To the front face of this second film is fastened by peripheral adhesive bonding 63 a first redirection optical film 5 with array of asymmetric prisms with a long side 51 and a short side 52 extending longitudinally in the reference direction.

The normal N to the long side is directed toward the face F2 and oriented toward the top of the rear window or of the windshield (for a redirection toward the ground).

The front face of this redirection film is fastened by peripheral adhesive bonding 64 (glue, double-sided adhesive, etc.) to face F2 (or F4 if laminated); this is optional because here a protective rear film 7 with adhesive 65, here a bilayer 70, 71, covers and extends beyond the assembly consisting of the OLED and the optic 5a, 5b, 5. For example, this film 7, 70 is tinted (in its bulk) or bears an electrically conductive functional layer 71 (solar control, etc.) on one of its main faces.

The back window is for example oriented between 12° and 80° from the ground and for example from 50 to 70°.

The film for example redirects the light by an angle of at least 15° toward the ground. The OLED 3 includes a connector 35 that extends beyond the edge face of the first glazing, which is here fastened entrance-surface side on its periphery.

The OLED 3 is a back-emitting LED including a carrier 3′, which bears on the side opposite face F2 in this order starting from the carrier: an optional functional sublayer 31, a transparent anode 32, an organic electroluminescent system 33, a reflective cathode 34 and a (resin) encapsulating layer 36.

FIG. 3a is a face-on view of a monolithic deflector 300 (fixed side window) with OLED providing collimated and redirected light according to the invention.

FIG. 3b is a cross-sectional view of the deflector (fixed side window) with OLED providing collimated and redirected light according to the invention.

This deflector comprises a transparent first glazing 1 made of organic or mineral glass, with main faces 11, 12 called faces F1 and F2, and an edge face 10, and a so-called reference direction that is the normal to the horizontal in the plane of the (optionally curved) glazing. It is for example of quadrilateral shape with an upper edge of smaller width. It includes a masking layer 15 (black enamel, etc.) for example on face F2 and equipped with an aperture 15a.

The OLED 3 faces the aperture 15a and is interior-side and emits MV yellow toward face F2 and has an emitting area of length of at least 5 cm and of width of at least 1 cm, and is preferably of submillimeter-sized thickness E0, with an emission half angle at the apex of 50° to 70° and a main emission direction normal to the plane of said OLED.

For example, it is a question of a luminous strip that is rectangular (or any other shape) on the lower border.

To the exit surface of the OLED is fastened by peripheral adhesive bonding 60 a first optical film 5a with said array of prisms extending longitudinally along a first axis (see FIG. 3b).

To the front face of this first film is fastened by peripheral adhesive bonding 61 a second optical film 5b with the second array of prisms extending longitudinally along a second axis making an angle to said first axis of 90°; the first or second axis makes to the reference direction a zero angle.

To the front face of this second film is fastened by peripheral adhesive bonding 62 a first redirection optical film 5 with array of asymmetric prisms with a long side 51 and a short side 52 extending longitudinally in the reference direction.

The normal N to the long side is directed toward the face F2 and oriented toward the front of the deflector (for a redirection toward the rear).

The front face of this redirection film is fastened by peripheral adhesive bonding 64 to face F2; this is optional because here a protective rear film 7 with adhesive 65, here a bilayer 70, 71, covers and extends beyond the assembly consisting of the OLED and the optic 5a, 5b, 5. For example, it is tinted or bears an electrically conductive functional (solar-control, etc.) layer 71.

The back window is for example oriented between 12° and 80° from the ground and for example from 50 to 70°.

The film for example redirects the light by an angle of at least 15° toward the ground.

The OLED 3 includes a connector 35 that extends beyond the edge face of the first glazing, which is here fastened entrance-surface side on its periphery.

As a variant, it is a question of a laminated glazing with adhesive bonding to face F4. The enamel may be on face F2 or F3 or F4 (each with an aperture).

In relation to the embodiment of FIG. 3a, FIG. 3c is a face-on detail view of the OLED 3 equipped with its collimation optic made up of an array of prisms extending along the horizontal H and its redirection optic 5 made up of an array of asymmetric prisms extending along the vertical on the side of the exit surface 30′.

Thin and transparent optical films are preferred and in particular a stack of two or three or more films is preferred.

With respect to the embodiment of FIG. 3a, FIG. 3b is an alternative face-on detail view of a plurality of side-by-side OLEDs 3 equipped with their collimation optics and redirection optics 5; between the OLEDs the optics (non-functional) may be of small width or even of zero width or without texture.

FIG. 4a is a cross-sectional view of a glazing 400a (back window or deflector or windshield) providing collimated and redirected light according to the invention.

This laminated vehicle (in particular motor-vehicle) back window 400a comprises:
a transparent first glazing 1, made of mineral or even organic glass, forming the exterior glazing, with main faces 11, 12 called faces F1 and F2, an edge face 10, and a so-called reference direction that is the horizontal between the lateral edges of the back window
a second glazing 1′, forming the interior glazing, for example made of TSA (or clear or extra-clear) glass and in particular of 2.1 mm thickness or even 1.6 mm thickness or even of less than 1.1 mm thickness (in particular chemically tempered glass), with third and fourth main faces 13, 14 called face F3 and face F4, respectively
between face F2 and face F3, which form the internal faces 12, 13 of the laminated glazing, a lamination interlayer 2, 21, 22 made of polymeric material, here made of PVB, of thickness that is at most 2 mm or submillimeter-sized and preferably of 1 mm or less, for example of 0.76 mm for a conventional PVB (RC41 from Solutia or Eastman) or, as a variant, if necessary, a (three-layer or four-layer) acoustic PVB for example of about 0.81 mm thickness, including a layer of PVB 21 with a face FB making adhesive contact with the (bare or coated) face F2 and an aperture 2a that emerges onto the face F2, the edge face 20 of this PVB being set back, for example by 2 mm, from the edge face of the glazings
an optional for example low-emissivity (ITO, etc.) functional layer on face F4 and/or alternatively face F3, which is optionally coated with a (heating, low-emissivity, etc.) functional layer
preferably internal and external peripheral masking layers 15′, 15 on face F1 11 or F3 or preferably on face F2 12 and even on F4 14, for example made of black enamel.

In the emergent aperture is housed an electroluminescent element that is an OLED 3 (or QLED or a TFEL) and that is able to emit MV red light in order to form a stoplight or another light (or MV yellow for an indicator side-repeater light) or that serves as an external symbolism (pictogram, etc.) emitted toward face F2 12, said OLED having an exit surface 30 toward face F2 and an opposite entrance surface 30 at the bottom of the aperture 2a. The OLED includes a connector 35 that extends beyond the edge face of the first glazing, which is here fastened entrance-surface side on its periphery. The OLED is for example a back-emitting LED.

Facing the OLED 3 is placed in this order:
a collimation optic 4, having a rear face 40 on the side of the exit surface of the OLED and a front face 40′ opposite to the rear face
a redirection optic 5, having a rear face on the side of the exit surface and a front face opposite to the rear face.

As a variant, facing the OLED 3 is placed a holographic redirection optics having a rear face exit-surface side and a front face opposite to the rear face.

The emergent aperture 2a encircles the OLED 4 and the optic 4, 5 and even makes contact with its edge face or, as a variant, is spaced apart by at most 0.5 mm and even at most 0.1 mm from the edge face.

The following are for example chosen during manufacture: a first sheet 21, made of PVB, with one through—(or as a variant blind) aperture and a rear second sheet of PVB 22 on the side of the rear face 30. By reflow, the two sheets are joined with an interface (here shown by the dotted line) possibly being visible. If necessary, the OLED 3 is fastened beforehand to the rear sheet 22 by adhesive bonding 60 or by creating point adhesive contact by spot heating (and pressure). Point adhesive contact may be created between the two sheets 21, 22 outside of the zone of the OLED 3 before or after installation between the two glazings 1, 1′.

The collimation optic 4 is here a prismatic optical film or preferably a film comprising two-dimensional features (above all if singular) that is fastened on its periphery by a double-sided adhesive or a glue 60 to the exit surface (generating an air-filled cavity entry-side). It is for example a question of a plastic film that is partially textured in its thickness for example of less than 0.3 mm and made of PET. For example, the pitch is 160 μm and the height 80 μm and the remaining thickness is 175 μm with angle at the apex and valley side of 90° (+−20 arc). Air is between the exit surface and the entrance face of this single first optical film of the collimation optic. Air is between the features (prisms, etc.) of the front face of the collimation optic 4; the apexes of the features make physical contact with the redirection optic 5.

The redirection optic 5 is here an asymmetric prismatic optical film against or preferably as here fastened on its periphery by a double-sided adhesive or a glue 60 to the front face of the optic 4 (generating an air-filled cavity on the side of the entrance of the redirection optic 5) and preferably against or as here fastened on its periphery by a double-sided adhesive or a glue 60 to face F2 (generating an air-filled cavity exit-side). Air is between the prisms of the front face of the redirection optic; the apexes of the features optionally make physical contact with face F2 12. The stack of the two films 4, 5 may be very thin.

FIG. 4b is a cross-sectional view of a glazing 400b (back window or deflector or windshield) providing collimated and redirected light according to the invention.

This figure differs from FIG. 4a in that the collimation optic 4 and the redirection optic 5 are larger than the OLED 3 and than the emergent aperture (than the through-aperture of the second sheet 21) and are here fastened to (or against) the face of the PVB 21 by adhesive bonding 62 or before lamination by creating point adhesive contact by spot heating (and pressure).

The redirection optic 5 is here an asymmetric prismatic optical film against or preferably as here fastened on its periphery by a double-sided adhesive or a glue 60 to the front face of the optic 4 (generating an air-filled cavity entry-side) and preferably against or as here fastened on its periphery by a double-sided adhesive or a glue 60 to face F2 12. Air is between the prisms of the front face of the redirection optic; the apexes of the features optionally make physical contact with face F2.

FIG. 4c is a cross-sectional view of a glazing 400c (back window or deflector or windshield) providing collimated and redirected light according to the invention.

This figure differs from the preceding figure in that the collimation optic 4 and the redirection optic 5, again in the emergent aperture, are larger than the OLED 3, and the collimation optic 4 is adhesively bonded by adhesive 61 to the PVB 22 (front face of the rear PVB sheet 22) with or without use of a spacer.

The redirection optic 5 is against or as here fastened on its periphery by a double-sided adhesive or a glue 60 to face F2 12.

FIG. 4d is a cross-sectional view of a glazing 400d (back window or deflector or windshield) providing collimated and redirected light according to the invention.

This figure differs from FIG. 4a in that the aperture in the PVB is internal. For example, during manufacture a front PVB sheet 23 is placed on the apertured sheet 21 (which becomes a central sheet).

To prevent flow during the lamination from suppressing the optical function of the redirection optic 5, a local plastic protective film 7, for example of less than 0.3 mm thickness and made of PET, is adhesively bonded on its periphery to the front face of the redirection prismatic optical film 5.

This film 7 may be a color filter (white OLED and red or yellow filter, etc.).

The redirection optic 5 is here an asymmetric prismatic optical film against or as here fastened on its periphery by a double-sided adhesive or a glue 60 to the plastic protective film 7.

FIG. 4e is a cross-sectional view of a glazing 400e (back window or deflector or windshield) providing collimated and redirected light according to the invention.

This figure differs from the preceding figure in that the plastic protective film 7 is a covering film for example of less than 0.3 mm thickness and made of PET that is adhesively bonded on its periphery to the front face of the redirection prismatic optical film 5 and/or that simply covers (closes) the emergent aperture. It makes adhesive contact with the front PVB 23 and is for example preassembled therewith (functional PET/front PVB together before lamination) and with the PVB 21 (outside the aperture zone).

This film 7, 71 may be tinted and/or have an electrically conductive functional coating 72 face-F2 or face-F3 side: solar control, low-E, etc.

The redirection optic 5 is here an asymmetric prismatic optical film against or as here fastened on its periphery by a double-sided adhesive or a glue 60 to the plastic protective film 7.

FIG. 5 is a cross-sectional view of a glazing 500 (back window or deflector or windshield) with OLED providing collimated and redirected light according to the invention.

This figure differs from FIG. 4d in that an identical second prismatic film 4′ has been added that is crossed at 90° and adhesively bonded 61 (welded, etc.) on its periphery to the prismatic first film and to the redirection film 5.

The redirection optic 5 is here an asymmetric prismatic optical film against or as here fastened on its periphery by a double-sided adhesive or a glue 60 to the plastic protective film 7.

FIG. 6a is a cross-sectional view of a glazing 600a (back window or deflector or windshield) with OLED providing collimated and redirected light according to the invention.

This figure differs from FIG. 4a in that the collimation optic 4 (again a textured plastic film, for example a film made of PET of less than 0.6 mm thickness) bears two-dimensional features.

Each two-dimensional feature being defined by a flank and, in a plane P normal to the film, each two-dimensional feature has an angle at the apex ranging from 60 to 110°, each intersection of the flank with the plane P making with the plane of the film an angle ranging from 30 to 55°. Preferably, an angle at the apex (in the plane P) of 90° is chosen and the other angles are chosen to be 45°.

The redirection optic 5 is here an asymmetric prismatic optical film against or as here fastened on its periphery by a double-sided adhesive or a glue 60 to face F2.

FIG. 6b is a cross-sectional view of a glazing 600b with OLED providing collimated and redirected light according to the invention.

This figure differs from FIG. 6a in that the collimation optic 4 is adhesively bonded to a spacer frame 163a encircling the OLED 3, which is for example against or adhesively bonded to the rear PVB 22.

FIG. 7a is a view showing a step of mounting, not during lamination, the OLED 3 with the collimation optic 4 and redirection optic 5 on a first PVB lamination-interlayer sheet 22 with the aim of producing the vehicle glazing according to the invention.

The collimation optic (a prismatic film or two films that are crossed or that have 2D features) is premounted on the OLED 3 by peripheral adhesive bonding and the redirection optic 5 on the collimation optic.

A second sheet 21 is used with a through-aperture housing the assembly and with a connector 35 protruding (side of the entrance surface of the OLED 3). The whole lot is placed on the rear sheet 22 (face 22b) with local adhesive contact optionally being created by heating and/or pressure (roller) between PVB 21 and PVB 22 outside of the OLED zone or between the OLED and PVB 22 and/or between the connector and the PVBs 21, 22.

As a variant, the apertured sheet is put in place first and bits of it are removed in order to allow assemblies consisting of an OLED and optics to be placed in one or more marked zones.

If a third PVB sheet is added exit-surface side (front PVB) it is necessary to use a covering or local protective film between the redirection optic and the rear face of this front PVB sheet. For example, a thin transparent plastic film (that may even be colored, white OLED) and even a film comprising a functional layer may be used.

FIG. 7b is a view showing a step of mounting, not during lamination, the OLED with the collimation and redirection optic on a first PVB lamination-interlayer sheet with the aim of producing the glazing according to the invention.

This figure differs from the preceding figure in that the rear surface of the OLED is fastened by adhesive bonding 60 to the rear sheet 22.

If a third PVB sheet is added exit-surface side (front PVB) it is necessary to use a covering or local protective film between the redirection optic 5 and the rear face of this front PVB sheet. For example, a thin transparent plastic film and even a film comprising a functional layer may be added.

FIG. 7c is a view showing a step of mounting, not during lamination, the OLED with the collimation and redirection optic on a first PVB lamination-interlayer sheet with the aim of producing the glazing according to the invention.

This figure differs from the preceding figure in that (again) no second sheet with through- or blind aperture is used.

Provision is made to assist with the positioning of the OLED using a film 90 with a reference mark 91 that is either non-stick and against the face 22a or opposite the transparent (glass) lamination table.

If a third PVB sheet is added exit-surface side (front PVB) it is necessary to use a covering or local protective film between the redirection optic 5 and the rear face of this front PVB sheet. For example, a thin transparent plastic film and even a film comprising a functional layer may be used.

FIG. 7d is a view showing a step of mounting, not during lamination, the OLED with the collimation and redirection optic on a first PVB lamination-interlayer sheet with the aim of producing the glazing according to the invention.

This figure differs from FIG. 7a in that the collimation optic 4 and the redirection optic 5 are larger than the through-hole 25 of the PVB 21 and the collimation optic 4 is fastened against the front face of the apertured PVB sheet 21 by adhesive bonding or as a variant by creating adhesive contact (heating and/or pressure). The optic 4 closes the hole and is spaced apart from the OLED 3.

If a third PVB sheet is added exit-surface side (front PVB) it is necessary to use a covering or local protective film between the redirection optic and the rear face of this front PVB sheet. For example, a thin transparent plastic film and even a film comprising a functional layer may be used.

FIG. 7e is a view showing a step of mounting, not during lamination, the OLED with the collimation and redirection optic on a first PVB lamination-interlayer sheet with the aim of producing the glazing according to the invention.

This figure differs from FIG. 7c in that the collimation optic 4, which is larger than the OLED, is fastened against the front face of the rear sheet 22 by adhesive bonding 52 with or without spacer.

If a third PVB sheet is added exit-surface side (front PVB) it is necessary to use a covering or local protective film between the redirection optic 5 and the rear face of this front PVB sheet. For example, a thin transparent plastic film and even a film comprising a functional layer may be used.

FIG. 7f is a view showing a step of mounting, not during lamination, the OLED with the collimation and redirection optic on a first PVB lamination-interlayer sheet with the aim of producing the glazing according to the invention.

This figure differs from FIG. 7b in that the second PVB sheet 23 comprises a blind aperture 25 and the bottom of the redirection optic 5 is protected by a local protective plastic film in the aperture.

FIG. 7g is a view showing a step of mounting, not during lamination, the OLED with the collimation and redirection optic on a first PVB lamination-interlayer sheet with the aim of producing the glazing according to the invention.

This figure differs from the FIG. 7f in that the protective film is adhesively bonded to the bottom by adhesive bonding or creating local adhesive contact (heating and/or pressure).

1. An external luminous signaling vehicle glazing chosen from a side window, a rear window or a windshield, comprising:
a transparent first glazing, made of mineral or organic glass, with first and second main faces, and an edge face;
a light source on the second main face side and able to emit external signaling light, said light source having an exit surface toward the second main face;
wherein the light source is an electroluminescent element which has an emitting area of length of at least 5 cm and of width of at least 1 cm, with an emission half angle at the apex of 50° to 70° and a main emission direction normal to the plane of said electroluminescent element wherein, in one configuration, the external luminous signaling vehicle glazing comprises, facing said electroluminescent element, between the second main face and said electroluminescent element, a collimation optic having a rear face exit-surface side and a front face called the collimation face opposite the rear face,
the collimation optic, which is made of transparent material, includes an optical film or a set of optical films each including on a front face opposite to the exit surface an array of features with apexes and with a pitch T between apexes that is from 10 μm to 500 μm, the collimation optic includes:
a) a first optical film, with said array of features that are two-dimensional,
b) or a set of at least two optical films that are prismatic, including in this order starting from the exit surface:
a first optical film with said array of features that are prisms extending longitudinally along a first axis,
and, facing the first optical film, a second optical film with the second array of features that are prisms extending longitudinally along a second axis making an angle to said first axis of 90±10°, the first or second axis makes to a reference direction of the transparent first glazing an angle of at most 10°,
c) or a single first optical film with said array of features that are prisms, the array of prisms extending longitudinally along an axis that makes an angle of at most 10° to the reference direction,
wherein for a) each two-dimensional feature being defined by a flank and in a plane P normal to the film each two-dimensional feature has an angle at the apex ranging from 60 to 110°, each intersection of the flank with the plane P making with the plane of the optical film an angle ranging from 30 to 55°,
wherein for b) and c) each prism being defined by two longitudinal faces, each prism has an angle at the apex ranging from 60 to 110°, and each longitudinal face makes an angle ranging from 30 to 55° to the plane of the prismatic optical film,
wherein the external luminous signaling vehicle glazing comprises facing the collimation optic, a redirection optic, between the collimation optic and the second main face, made of transparent material, includes a redirection optical film or a set of redirection optical films each including on a front face opposite to the exit surface an array of asymmetric prisms with apexes and with a pitch T′ between apexes that is from 10 μm to 500 μm, the redirection optic thus includes:
i) a first asymmetric optical film with the set of asymmetric prisms extending longitudinally along a third axis that makes an angle of at most 10° to the reference direction,
j) or a set of two asymmetric optical films that are prismatic, including in this order starting from the exit surface:
a first asymmetric optical film with the set of asymmetric prisms extending longitudinally along a third axis that makes an angle of at most 10° to the reference direction,
and facing the first asymmetric optical film, a second asymmetric optical film with the second array of prismatic features, the set of prisms of the second array extending longitudinally along a fourth axis making an angle to said third axis of at most 10° and/or the fourth axis makes an angle with the reference direction of the glazing of at most 10°,
wherein for i) or j) each asymmetric prism being defined by first and second longitudinal faces, each prism makes an angle to the apex ranging from 50 to 60°, and a first longitudinal face forming a long side, makes to the plane of the asymmetric optical film an angle ranging from 31° to 41°,
wherein:
the reference direction for the rear window or the windshield is the horizontal in the plane of the rear window or windshield,
and the reference direction for the side window is the normal to the horizontal in the plane of the side window,
the normal to the long side directed toward the second main face is oriented toward the top of the rear window or of the windshield or toward the front of the side window
and wherein
air is between the exit surface and the entrance face of the first optical film of the collimation optic
for b) and c) air is between the prisms of the front face of the collimation optic,
for a) the two-dimensional features are recessed, the array of two-dimensional features is an array of cavities, the apexes S are oriented opposite to the second main face and the top surface of each cavity is spaced apart from or in physical contact with the asymmetric prismatic film, air is in the cavities, or the two-dimensional features are raised, the apexes of the two-dimensional features of each front face are spaced apart or in physical contact with the asymmetric prismatic film, air is between the two-dimensional features
air is between the asymmetric prisms, the final front face of the asymmetric prismatic film is spaced apart from or in physical contact with a transparent element that is distinct from or that corresponds to the first glazing,
or wherein, in an alternative configuration, the glazing includes facing the exit surface a holographic redirection optic, the holographic redirection optic includes a front face toward the second main face and an opposite rear face, the holographic redirection optic includes a film with an array of holographic features on the front face and air is between the exit surface and the entrance face of the holographic redirection optic and air is between the raised holographic features of the front face of the holographic redirection optic or air is in the recessed holographic features of the front face of the holographic redirection optic, the front face of the holographic redirection film is spaced apart from or in physical contact with a transparent element that is distinct from or that corresponds to the first glazing.

2. The external luminous signaling vehicle glazing as claimed in claim 1, wherein:
for the rear window, the light source emits in the red,
or, for the rear window or windshield, the light source emits in the yellow,
and/or for the rear window or the windshield, the light source is a pictogram.

3. The external luminous signaling vehicle glazing as claimed in claim 1, comprising a plurality of electroluminescent elements, each with the holographic redirection optic or with the assembly consisting of the collimation optic and the asymmetric redirection optic.

4. The external luminous signaling vehicle glazing as claimed in claim 1, wherein, for the side window, the light source emits in the yellow.

5. The external luminous signaling vehicle glazing as claimed in claim 1, wherein the prisms or the two-dimensional features are contiguous or essentially contiguous.

6. The external luminous signaling vehicle glazing as claimed in claim 1, wherein the or each optical film is a plastic film that is partially textured in its thickness.

7. The external luminous signaling vehicle glazing as claimed in claim 1, wherein the electroluminescent element is an organic light-emitting diode, or a quantum-dot light-emitting diode.

8. The external luminous signaling vehicle glazing as claimed in claim 1, comprising a color filter, which is:
between the exit surface and the rear face of the collimation optic,
or
between the exit surface and the rear face of the holographic redirection optic,
or
between the redirection optic and a lamination interlayer, said filter then forming a protective film.

9. The external luminous signaling vehicle glazing as claimed in claim 1, wherein the electroluminescent element is a back-emitting OLED including a carrier that bears, side opposite the second main face, in this order starting from the carrier: an optional functional sublayer, a transparent anode, an organic electroluminescent system, a reflective cathode.

10. The external luminous signaling vehicle glazing as claimed in claim 1, wherein the first glazing is curved and the electroluminescent element is flexible.

11. The external luminous signaling vehicle glazing as claimed in claim 1, further comprising an element for electrically connecting said electroluminescent element, which is connected to said electroluminescent element and which extends beyond the edge face of the first glazing.

12. The external luminous signaling vehicle glazing as claimed in claim 1, wherein the collimation optic is fastened to the electroluminescent element on the periphery of the exit surface, fastened via its rear face, and wherein the asymmetric redirection optic is fastened to the periphery of the final front face of the collimation optical film or wherein the holographic redirection optic is fastened to the electroluminescent element on the periphery of the exit surface, fastened via its rear face.

13. The external luminous signaling vehicle glazing as claimed in claim 1, comprising a laminated glazing including:
said first transparent glazing,
a second transparent glazing made of mineral or organic glass, with third and fourth main faces,
between the second and third main faces, which are the internal faces of the laminated glazing, a transparent lamination interlayer that is optionally tinted and/or optionally composite in its thickness, made of polymeric material, the lamination interlayer film having a main face oriented toward the third main face side and making adhesive contact with the third main face and another main face oriented toward the second main face side and making adhesive contact with the second main face, the electroluminescent element being between the second and third main faces.

14. The external luminous signaling vehicle glazing as claimed in claim 1, wherein the optionally holographic or asymmetric redirection optic is against or fastened to the transparent element on the periphery of the final front face to the second main face or a fourth main face of a laminated glazing including a second transparent glazing made of mineral or organic glass, with a third main face and the fourth main faces.

15. The external luminous signaling vehicle glazing as claimed in claim 1, comprising a laminated glazing including:
said first transparent glazing,
a second transparent glazing made of mineral or organic glass, with third and fourth main faces,
between the second and third main faces, which are the internal faces of the laminated glazing, a transparent lamination interlayer, which is optionally tinted and/or optionally composite in its thickness, made of polymeric material, said lamination interlayer film having a main face oriented toward the third main face side and making adhesive contact with the third main face and another main face oriented toward the second main face side and making adhesive contact with the second main face, the collimation optic is larger than the electroluminescent element and is fastened on its periphery by an adhesive, or on its periphery makes adhesive contact via its rear face with said lamination interlayer and optionally the asymmetric redirection optic is larger than the electroluminescent element and is fastened on its periphery by an adhesive via its rear face to the collimation optic,
or the collimation optic is fastened on its periphery by an adhesive to the exit surface and the asymmetric redirection optic is larger than the electroluminescent element and is fastened on its periphery by an adhesive to said lamination interlayer or makes on its periphery adhesive contact via its rear face with said lamination interlayer or the holographic redirection optic is larger than the electroluminescent element and is fastened on its periphery and preferably adhesively bonded by an in particular transparent adhesive to said lamination interlayer or makes on its periphery adhesive contact via its rear face with said lamination interlayer.

16. The external luminous signaling vehicle glazing as claimed in claim 1, wherein the second main face is free, the glazing is monolithic, the asymmetrical or holographic redirection optic is on the second main face or if the glazing is laminated and the electroluminescent element is on the side of a free face of a second transparent glazing:
the optionally holographic redirection optic is fastened on its periphery to the electroluminescent element, via its rear face,
or the collimation optic is fastened on its periphery to the electroluminescent element, via its rear face,
and/or wherein the assembly consisting of the electroluminescent element/collimation optic/asymmetric redirection optic or the assembly consisting of the electroluminescent element/holographic redirection optic is fastened to the free face via a protective rear film that is on the entrance surface of said electroluminescent element with a protruding fastening portion that extends onto the free face.

17. The external luminous signaling vehicle glazing as claimed in claim 13, wherein the holographic direction optic or the collimation optic is between the second and the third main face, the electroluminescent element is between the second and the third main face and in the zone with the electroluminescent element the main face makes adhesive contact with the third main face or with the side of the exit surface, and the other main face makes adhesive contact with the second main face and the transparent element is a plastic protective film, on the final front face, with a face oriented toward the second main face and makes adhesive contact with the lamination interlayer, the protective plastic film being local optionally with an extension zone extending beyond the edges of the final front face by at most 10 cm.

18. The external luminous signaling vehicle glazing as claimed in claim 14, wherein the lamination interlayer is composite and includes the following stack outside of the zone of the electroluminescent element: PVB/functional plastic film with an optional electrically conductive functional coating oriented toward the second main face or the third main face side/PVB, the functional plastic film extending over second main face, and wherein the electroluminescent element is between the second main face and the third main face, between the front face and the third main face is present said plastic film/said PVB, the transparent element is the functional plastic film on the front face.

19. The external luminous signaling vehicle glazing as claimed in claim 12, wherein the lamination interlayer includes an acoustic PVB and/or is tinted.

20. The external luminous signaling vehicle glazing as claimed in claim 13, wherein the electroluminescent element is housed in an aperture of the lamination interlayer, the aperture is blind with a bottom in the direction of the third main face and opens onto the second main face, or the aperture is in the thickness of the lamination interlayer and said transparent element is a protective film housed in said aperture or larger than said aperture and covering said aperture.

21. A vehicle including at least one luminous glazing as claimed in claim 1.

22. A process for manufacturing an external luminous signaling vehicle glazing as claimed in claim 1, comprising, before installation on the first glazing, pre-mounting, on the electroluminescent element:
the film-based collimation optic,
or the film-based holographic redirection optic, in particular by peripheral fastening and even by peripheral adhesive bonding optionally forming a seal
and an optionally colored protective film on the last redirection optical film.

23. A process for manufacturing an external luminous signaling vehicle laminated glazing as claimed in claim 13, comprising:
positioning the electroluminescent element on an unapertured lamination interlayer or in a through- or blind aperture and simultaneously or separately positioning the collimation optic and the asymmetric redirection optic or the holographic redirection optic facing the electroluminescent element
and successively:
installing the assembly positioned between the first and second glazing,
laminating under vacuum and with heating or even under pressure.

24. The process for manufacturing an external luminous signaling vehicle laminated glazing as claimed in claim 23, wherein the electroluminescent element is positioned on said lamination-interlayer sheet in a through- or blind aperture entrance-surface side, with the holographic redirection optic or with the collimation optic or even indeed the asymmetric redirection optic housed in the aperture and fastened, on the periphery of the exit surface or with the asymmetric or holographic redirection optic capping the aperture and on said lamination-interlayer sheet.

25. The process for manufacturing an external luminous signaling vehicle laminated glazing as claimed in claim 23, comprising, before said positioning, fastening an, optionally colored, local protective film to the final front face of the holographic or asymmetric redirection optic and during said positioning said lamination interlayer has a blind hole housing the local protective film or said lamination interlayer has a through-hole and another lamination interlayer closes the hole.

26. The process for manufacturing an external luminous signaling vehicle laminated glazing as claimed in claim 23, wherein said lamination interlayer having a through-hole housing the electroluminescent element, and the collimation optic and the asymmetric redirection optic or the electroluminescent element and the holographic redirection optic, the process includes placing an, optionally colored, protective film closing the hole and another interlayer sheet covering the protective film, said other sheet optionally already making adhesive contact with the local covering or protective film.

27. The process for manufacturing an external luminous signaling vehicle laminated glazing as claimed in claim 23, comprising creating point adhesive contact by heating and pressure outside of the zone of the electroluminescent element
between said interlayer sheet and another rear interlayer sheet entrance-surface side and/or between said interlayer sheet and another front interlayer sheet exit-surface side,
and/or between the collimation optic and the asymmetric redirection optic or the holographic redirection optic and the interlayer sheet or another interlayer sheet
the electroluminescent element or the electroluminescent element and the holographic redirection optic being in a through or blind hole of one of said interlayer sheets and/or the electroluminescent element or the electroluminescent element and the holographic redirection optic being sandwiched between said interlayer sheet and the front or back other interlayer sheet.
